(19) United States
(12) Patent Application Publication
(10) Pub. No.: US 2023/0280570 A1
(43) Pub. Date: Sep. 7, 2023

(54) FIXED FOCUS IMAGE CAPTURING LENS

(71) Applicant: Rays Optics Inc., Hsinchu County (TW)

(72) Inventor: Ching-Sheng Chang, Hsinchu County (TW)

(73) Assignee: Rays Optics Inc., Hsinchu County (TW)

(21) Appl. No.: 17/864,433

(22) Filed: Jul. 14, 2022

(30) Foreign Application Priority Data
Mar. 1, 2022 (TW) 111107232

(51) Int. Cl. G02B 13/18

(52) U.S. Cl. CPC G02B 13/18; H04N 5/2254

(57) ABSTRACT

A fixed focus image capturing lens, including a first lens group, a second lens group, and an aperture, is provided. The first lens group includes a first lens, a second lens, a third lens, and a fourth lens in sequence from an object side of the fixed focus image capturing lens to an image side thereof. The refractive powers of the first lens, the second lens, and the third lens are all negative. The second lens group includes four lenses having refractive power. The four lenses include a cemented lens. The aperture is disposed between the first lens group and the second lens group.

### CROSS-REFERENCE TO RELATED APPLICATION

This application claims the priority benefit of Taiwan application serial no. 111107232, filed on Mar. 1, 2022. The entirety of the above-mentioned patent application is hereby incorporated by reference herein and made a part of this specification.

### BACKGROUND

### Technical Field

The disclosure relates to an optical lens, and in particular to a fixed focus image capturing lens.

### Description of Related Art

The optical lens may be divided into a projection lens and an image capturing lens, wherein the projection lens projects an image generated by a display element onto a screen or the retina of the human eye, and the image capturing lens images an external scene on an image sensor.

The image capturing lens may be further divided into a fixed focus image capturing lens and a zoom image capturing lens. The zoom image capturing lens is often used in cameras for users to adjust the field of view to obtain the desired image capturing range and magnification. A wide-angle fixed focus image capturing lens may be used in a vehicle lens, a security surveillance lens, or an action camera, or may be applied to day and night environments.

It is difficult for a traditional wide-angle lens to have both a wide viewing angle and a high imaging quality under a large aperture, and it is difficult to meet the requirements for low chromatic aberration above blue light (with a wavelength of, for example, 420 nm) and red light (with a wavelength of, for example, 850 nm). In addition, conventional consumer lens materials cannot provide drivers with reliable performance and clear vision under extreme temperatures and harsh environments.

### SUMMARY

The disclosure provides a fixed focus image capturing lens, which can have a wide viewing angle, a high imaging quality, day and night confocal, and low chromatic aberration.

An embodiment of the disclosure provides a fixed focus image capturing lens, which includes a first lens group, a second lens group, and an aperture. The first lens group includes a first lens, a second lens, a third lens, and a fourth lens in sequence from an object side of the fixed focus image capturing lens to an image side of the fixed focus image capturing lens, and refractive powers of the first lens, the second lens, and the third lens are all negative. The second lens group is disposed between the first lens group and the image side of the fixed focus image capturing lens, and includes four lenses having refractive power. The four lenses include a cemented lens. The aperture is disposed between the first lens group and the second lens group. The fixed focus image capturing lens satisfies following conditions of (1) enabling a distance difference between a 555 nm wavelength light focusing surface and an 850 nm wavelength light focusing surface to be less than 20 μm; and (2) 0.61<D1/LT<0.97, where D1 is a lens outer diameter of an outermost surface of the first lens, and LT is a distance between outermost lens surfaces on two sides of the fixed focus image capturing lens on an optical axis.

An embodiment of the disclosure provides a fixed focus image capturing lens, which includes a first lens group, a second lens group, and an aperture. The first lens group is disposed with a first lens having negative refractive power, a second lens having refractive power, and a third lens having negative refractive power in sequence from a magnification side of the fixed focus image capturing lens to a reduction side of the fixed focus image capturing lens. The second lens group is disposed between the first lens group and the reduction side, and the second lens group includes at least one cemented lens. The aperture is disposed between the first lens group and the second lens group. A lens surface of the second lens group closest to the reduction side is concave. The fixed focus image capturing lens is substantially a day and night confocal lens, and meets a following condition of 0.06<EFL/LT<0.08, where EFL is an optical effective focal length of the fixed focus image capturing lens, and LT is a distance between outermost lens surfaces on two sides of the first lens group and the second lens group on an optical axis.

In the fixed focus image capturing lens according to the embodiments of the disclosure, the distance difference between the 555 nm wavelength light focusing surface and the 850 nm wavelength light focusing surface is less than 20 μm, or the fixed focus image capturing lens substantially has day and night confocal characteristics, and the fixed focus image capturing lens has the above-mentioned features. Therefore, the fixed focus image capturing lens according to the embodiments of the disclosure can have a wide viewing angle, a high imaging quality, day and night confocal, and low chromatic aberration.

### BRIEF DESCRIPTION OF THE DRAWINGS

FIG. 1 is a schematic cross-sectional view of a fixed focus image capturing lens according to a first embodiment of the disclosure.

FIG. 2A to FIG. 2D are optical imaging quality graphs of the fixed focus image capturing lens of FIG. 1.

FIG. 3 is a schematic cross-sectional view of a fixed focus image capturing lens according to a second embodiment of the disclosure.

FIG. 4A to FIG. 4D are optical imaging quality graphs of the fixed focus image capturing lens of FIG. 3.

FIG. 5 is a schematic cross-sectional view of a fixed focus image capturing lens according to a third embodiment of the disclosure.

FIG. 6A to FIG. 6D are optical imaging quality graphs of the fixed focus image capturing lens of FIG. 5.

FIG. 7 is a schematic cross-sectional view of a fixed focus image capturing lens according to a fourth embodiment of the disclosure.

FIG. 8A to FIG. 8D are optical imaging quality graphs of the fixed focus image capturing lens of FIG. 7.

FIG. 9 is a schematic cross-sectional view of a fixed focus image capturing lens according to a fifth embodiment of the disclosure.

FIG. 10A to FIG. 10D are optical imaging quality graphs of the fixed focus image capturing lens of FIG. 9.

FIG. 11A to FIG. 11F are respectively through focus modulation transfer function graphs of the fixed focus image capturing lens of FIG. 9 under visible light (420 nm to 650 nm), red light (650 nm), green light (550 nm), blue light (420 nm), infrared light (850 nm), and infrared light (940 nm) at a spatial frequency of 120 lp/mm.

FIG. 12 is a schematic cross-sectional view of a fixed focus image capturing lens according to a sixth embodiment of the disclosure.

FIG. 13A to FIG. 13D are optical imaging quality graphs of the fixed focus image capturing lens of FIG. 12.

FIG. 14 is a schematic cross-sectional view of a fixed focus image capturing lens according to a seventh embodiment of the disclosure.

FIG. 15A to FIG. 15D are optical imaging quality graphs of the fixed focus image capturing lens of FIG. 14.

FIG. 16 is a schematic cross-sectional view of a fixed focus image capturing lens according to an eighth embodiment of the disclosure.

FIG. 17A to FIG. 17D are optical imaging quality graphs of the fixed focus image capturing lens of FIG. 16.

### DETAILED DESCRIPTION OF DISCLOSED EMBODIMENTS

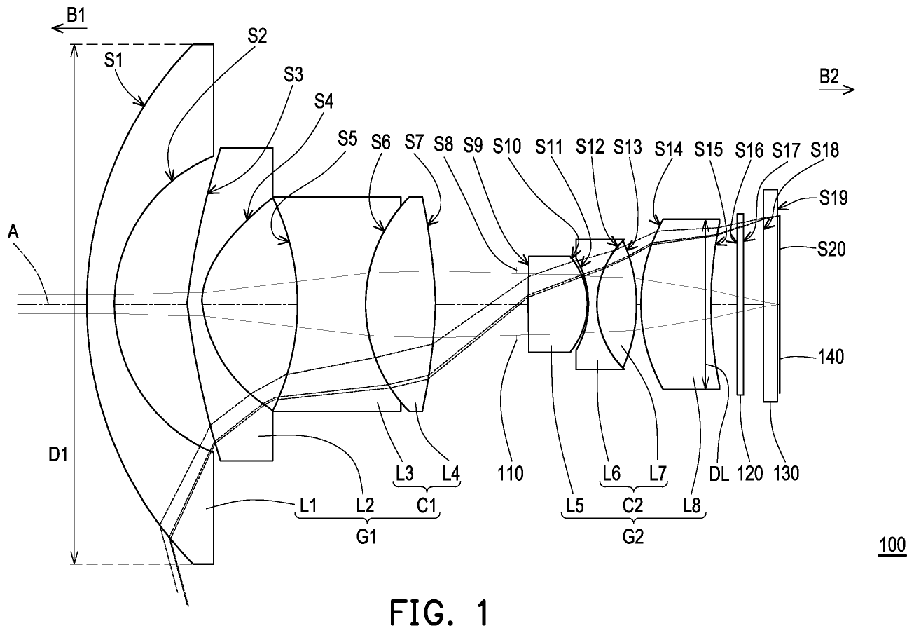

FIG. 1 is a schematic cross-sectional view of a fixed focus image capturing lens according to a first embodiment of the disclosure. Please refer to FIG. 1 first. A fixed focus image capturing lens 100 of the embodiment includes a first lens group G1, a second lens group G2, and an aperture 110. The first lens group G1 includes a first lens L1, a second lens L2, a third lens L3, and a fourth lens L4 in sequence from an object side B1 (that is, a magnification side) of the fixed focus image capturing lens 100 to an image side B2 (that is, a reduction side) of the fixed focus image capturing lens 100, and the refractive powers of the first lens L1, the second lens L2, and the third lens L3 are all negative. In the embodiment, the refractive power of the fourth lens L4 is positive. In addition, in the embodiment, the third lens L3 and the fourth lens L4 form a cemented lens C1, and the cemented lens C1 is, for example, a double cemented lens.

The second lens group G2 is disposed between the first lens group G1 and the image side B2, and the second lens group G2 includes four lenses having refractive power. The four lenses include a cemented lens C2. In the embodiment, the four lenses having refractive power are a fifth lens L5, a sixth lens L6, a seventh lens L7, and an eighth lens L8 arranged in sequence from the object side B1 to the image side B2. The refractive powers of the fifth lens L5, the sixth lens L6, the seventh lens L7, and the eighth lens L8 are positive, negative, positive, and positive in sequence, and the sixth lens L6 and the seventh lens L7 form the cemented lens C2, which is, for example, a double cemented lens. In the embodiment, the lens surface (that is, a surface S15 of the eighth lens L8 facing the image side B2) of the second lens group G2 closest to the reduction side (that is, the image side B2) is concave.

The aperture 110 is disposed between the first lens group G1 and the second lens group G2. The fixed focus image capturing lens 100 is substantially a day and night confocal lens and satisfies at least one of the following conditions of:
(1) enabling the distance difference between a 555 nm wavelength light focusing surface and an 850 nm wavelength light focusing surface to be less than 20 μm;
(2) 0.61<D1/LT<0.97, where D1 is the lens outer diameter of the outermost surface (that is, a surface S1) of the first lens L1, and LT is the distance between the outermost lens surfaces on the two sides of the fixed focus image capturing lens 100 on an optical axis A (that is, the distance between the surface S1 and the surface S15 on the optical axis A in the embodiment), wherein in an embodiment, 0.63<D1/LT<0.95 is satisfied, and in another embodiment, 0.65<D1/LT<0.93 is satisfied; and
(3) 0.06<EFL/LT<0.08, where EFL is the optical effective focal length of the fixed focus image capturing lens 100, and LT is the distance between the outermost lens surfaces on the two sides of the first lens group G1 and the second lens group G2 on the optical axis A (that is, the distance between the surface S1 and the surface S15 on the optical axis A in the embodiment), wherein in an embodiment, 0.063<EFL/LT<0.078 is satisfied, and in another embodiment, 0.065<EFL/LT<0.076 is satisfied.

In the fixed focus image capturing lens 100 of the embodiment, the distance difference between the 555 nm wavelength light focusing surface and the 850 nm wavelength light focusing surface is less than 20 μm, or the fixed focus image capturing lens 100 substantially has day and night confocal characteristics, and the fixed focus image capturing lens 100 has the above-mentioned features including the cemented lens. Therefore, the fixed focus image capturing lens 100 of the embodiment can have a wide viewing angle, a high imaging quality, day and night confocal, and low chromatic aberration.

In the embodiment, the materials of all lenses in the fixed focus image capturing lens 100 are all glass, that is, the materials of the first to eighth lenses L1 to L8 are all glass. In this way, the fixed focus image capturing lens 100 may be ensured to maintain stable image quality under harsh environments, high temperatures, and low temperatures. Therefore, the fixed focus image capturing lens 100 is applicable to an advanced driver assistance system of an autonomous driving or assisted driving vehicle, and a captured image may be used for machine analysis. In addition, in the embodiment, the horizontal field of view of the fixed focus image capturing lens 100 may reach more than 190 degrees. The applicable wavelength coverage of the fixed focus image capturing lens 100 may be from 420 nm to 850 nm. The lateral chromatic aberration of the fixed focus image capturing lens 100 at 420 nm to 650 nm is less than 3 μm, and the lateral chromatic aberration at 850 nm is less than 9 μm, that is, the fixed focus image capturing lens 100 has low lateral chromatic aberration. In addition, the fixed focus image capturing lens 100 also has low axial color aberration at 420 nm to 850 nm, and the center field curvature of a monochromatic light of the fixed focus image capturing lens 100 is less than 10 μm.

The fixed focus image capturing lens 100 may include at least one aspherical lens. In the embodiment, the second lens L2, the fourth lens L4, and the fifth lens L5 are aspherical lenses, such as glass molded lenses. In addition, the first lens L1, the third lens L3, the sixth lens L6, the seventh lens L7, and the eighth lens L8 are spherical lenses and are glass lenses.

In the embodiment, the first lens L1 is a negative meniscus lens with a convex surface facing the object side B1, the second lens L2 is a negative meniscus lens with a convex surface facing the object side B1, the third lens L3 is a biconcave lens, the fourth lens L4 is a biconvex lens, the fifth lens L5 is a biconvex lens, the sixth lens L6 is a biconcave lens, the seventh lens L7 is a biconvex lens, and the eighth lens L8 is a positive meniscus lens with a convex surface facing the object side B1.

The following Table 1 lists the parameters of the surfaces of each optical element of the fixed focus image capturing lens 100 of the embodiment:

TABLE 1

| | | | | | Effec- | |
|---|---|---|---|---|---|---|
| | Radius of | | Refrac- | Abbe | tive | |
| Sur- | curvature | Spacing | tive | num- | radius | |
| face | (mm) | (mm) | index | ber | (mm) | Remark |
| S1 | 18.36 | 1.381 | 2.10 | 17 | 12.04 | First lens L1 |
| S2 | 7.96 | 3.629 | | | 7.41 | |
| S3 | 9.39 | 0.738 | 1.88 | 41 | 7.23 | Second lens L2 |
| S4 | 3.76 | 4.789 | | | 5.10 | |
| S5 | −10.20 | 3.397 | 1.46 | 87 | 5.00 | Third lens L3 |
| S6 | 7.61 | 3.499 | 1.94 | 29 | 4.28 | Fourth lens L4 |
| S7 | −14.77 | 4.046 | | | 3.88 | |
| S8 | Infinity | 0.581 | | | 1.53 | Aperture 110 |
| S9 | 36.85 | 2.954 | 1.75 | 47 | 1.53 | Fifth lens L5 |
| S10 | −3.75 | 0.050 | | | 2.22 | |
| S11 | −4.52 | 0.420 | 1.76 | 24 | 2.23 | Sixth lens L6 |
| S12 | 4.50 | 1.983 | 1.60 | 65 | 2.79 | Seventh lens L7 |
| S13 | −7.70 | 0.221 | | | 2.98 | |
| S14 | 8.63 | 3.500 | 1.61 | 64 | 3.77 | Eighth lens L8 |
| S15 | 19.36 | 1.317 | | | 3.94 | |
| S16 | 6.18 | 0.300 | 1.52 | 64 | 4.14 | Infrared cut-off |
| | | | | | | filter 120 |
| S17 | Infinity | 1.000 | | | 4.19 | |
| S18 | Infinity | 0.700 | 1.52 | 64 | 4.41 | Glass cover 130 |
| S19 | Infinity | 0.045 | | | 4.52 | |
| S20 | Infinity | 0.000 | | | 4.53 | Image sensor 140 |

In Table 1, the spacing refers to the distance between a surface of a current row to a surface of a next row on the optical axis A. For example, the spacing of the row S1 is 1.381 mm, which represents that the distance between the surface S1 and the surface S2 on the optical axis A is 1.381 mm. The surfaces S1 and S2 are the two opposite surfaces of the first lens L1, the surfaces S3 and S4 are the two opposite surfaces of the second lens L2, the surface S5 is the surface of the third lens L3 facing the object side B1, the surface S6 is the surface connecting the third lens L3 and the fourth lens L4, and the surface S7 is the surface of the fourth lens L4 facing the image side B2. The surface S8 is where the aperture 110 is located, wherein the aperture 110 is formed, for example, by an aperture stop. The surfaces S9 and S10 are the two opposite surfaces of the fifth lens L5. The surface S11 is the surface of the sixth lens L6 facing the object side B1, the surface S12 is the surface connecting the sixth lens L6 and the seventh lens L7, and the surface S13 is the surface of the seventh lens L7 facing the image side B2. The surfaces S14 and S15 are the two opposite surfaces of the eighth lens L8. The surfaces S16 and S17 are the two opposite surfaces of the infrared cut-off filter 120. The surfaces S18 and S19 are the two opposite surfaces of the glass cover 130. The surface S20 is the sensing surface of the image sensor 140, that is, the imaging plane of the fixed focus image capturing lens 100. In the embodiment, the image sensor 140 is, for example, a complementary metal oxide semiconductor (CMOS) image sensor, a charge coupled device (CCD), or other suitable image sensors.

In the above surface, the surfaces S3, S4, S7, S9, and S10 are aspherical surfaces, which may be expressed by the following aspherical surface equation:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i} \qquad ( 1 )$$

In the above Equation (1), R is the radius of curvature of a lens surface near the optical axis A; Y is the vertical distance between a point on an aspherical curved surface and the optical axis A; Z is the depth of an aspherical surface (the vertical distance between the point on the aspherical surface with the distance Y from the optical axis A and the tangent to the vertex on the optical axis A of the aspherical surface); K is a conic constant; and a₂ᵢ is the 2i-th order aspherical coefficient. The following Table 2 lists the aspherical parameters of the surfaces S3, S4, S7, S9, and S10 of the fixed focus image capturing lens 100 of the embodiment:

TABLE 2

| Surface | K | a₄ | a₆ | a₈ |
|---|---|---|---|---|
| S3 | 0.00 | −8.87E−04 | 1.65E−06 | 1.12E−07 |
| S4 | −0.92 | −8.23E−05 | −2.76E−05 | 5.45E−07 |
| S7 | 0.00 | 4.29E−04 | −9.48E−07 | 1.27E−08 |
| S9 | 0.00 | −1.81E−03 | −3.12E−04 | 4.87E−05 |
| S10 | 0.00 | 3.43E−04 | −1.05E−04 | 1.71E−05 |

| Surface | a₁₀ | a₁₂ | a₁₄ | a₁₆ |
|---|---|---|---|---|
| S3 | −1.81E−09 | 7.90E−12 | 0.00E+00 | 0.00E+00 |
| S4 | −3.51E−10 | 1.68E−13 | 0.00E+00 | 0.00E+00 |
| S7 | 0.00E+00 | 0.00E+00 | 0.00E+00 | 0.00E+00 |
| S9 | −2.25E−05 | 0.00E+00 | 0.00E+00 | 0.00E+00 |
| S10 | −3.49E−06 | 0.00E+00 | 0.00E+00 | 0.00E+00 |

In the embodiment, the aspherical coefficients a₂ of the surfaces S3, S4, S7, S9, and S10 are all zero.

In the embodiment, the at least one aspherical lens includes a lens second farthest from the aperture 110 (that is the second lens counted from the object side B1, that is, the second lens L2) in the first lens group G1, a lens closest to the aperture 110 (for example, the fourth lens L4 in the embodiment) in the first lens group G1, or a lens closest to the aperture 110 (for example, the fifth lens L5 in the embodiment) in the second lens group GB2. In addition, the f-number of the fixed focus image capturing lens 100 falls within the range of 2.05 to 2.20, and preferably falls within the range of 1.6 to 2.10, and may fall within the range of 1.8 to 2.2 in an embodiment. The f-number of the fixed focus image capturing lens 100 in the embodiment is, for example, 2.1.

In the embodiment, the ratio of the spacing between the first lens group G1 and the second lens group G2 on the optical axis A (for example, the distance between the surface S7 and the surface S9 on the optical axis A in the embodiment) to LT (that is, the distance between the outermost lens surfaces on the two sides of the first lens group G1 and the second lens group G2 on the optical axis A) falls within the range of 0.08 to 0.31. In addition, in the embodiment, the ratio of the spacing between the first lens group G1 and the second lens group G2 on the optical axis A to the distance between the two surfaces closest to and farthest from the aperture 110 (for example, the surface S1 and the surface S7 in the embodiment) of the first lens group G1 on the optical axis A falls within the range of 0.13 to 0.67. In the embodiment, the ratio of the thickness of the lens with the thickest center thickness (the fourth lens L4 in the embodiment) in the first lens group G1 of the fixed focus image capturing lens 100 on the optical axis A to the length of the first lens group G1 on the optical axis A (that is, the distance between the surface S1 and the surface S7 on the optical axis A in the embodiment) falls within the range of 0.12 to 0.40, and preferably falls within the range of 0.20 to 0.30. The fixed focus image capturing lens 100 may meet 7.52<TTL/IH<9.07, or may meet 7.52<TTL/IH<9.87 in an embodiment, where TTL is the distance between the lens surface farthest from the aperture 110 (that is, the surface S1 in the embodiment) of the first lens group G1 and an imaging plane (that is, the surface S20 in the embodiment) of the fixed focus image capturing lens 100 on the optical axis A, and IH is the image height of the fixed focus image capturing lens 100. In the embodiment, IH/TTL is equal to 0.13, and TTL/IH is approximately 7.69. The number of lenses having refractive power of the fixed focus image capturing lens 100 may be 8 to 10, and is, for example, 8 in the embodiment.

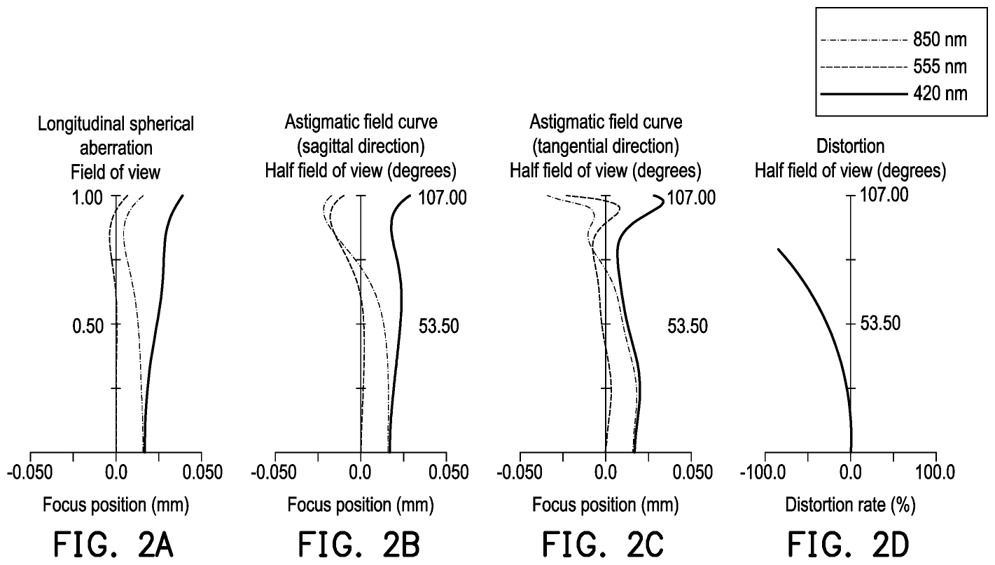

FIG. 2A to FIG. 2D are optical imaging quality graphs of the fixed focus image capturing lens of FIG. 1. FIG. 2A is a longitudinal spherical aberration diagram of the fixed focus image capturing lens 100, FIG. 2B is an astigmatic field curve in the sagittal direction of the fixed focus image capturing lens 100, FIG. 2C is an astigmatic field curve in the tangential direction of the fixed focus image capturing lens 100, and FIG. 2D is a distortion diagram of the fixed focus image capturing lens 100. The drawings are simulated using imaging rays with wavelengths of 850 nanometers (nm), 555 nm, and 420 nm. It can be seen from FIG. 2A to FIG. 2D that the imaging quality of the fixed focus image capturing lens 100 is good.

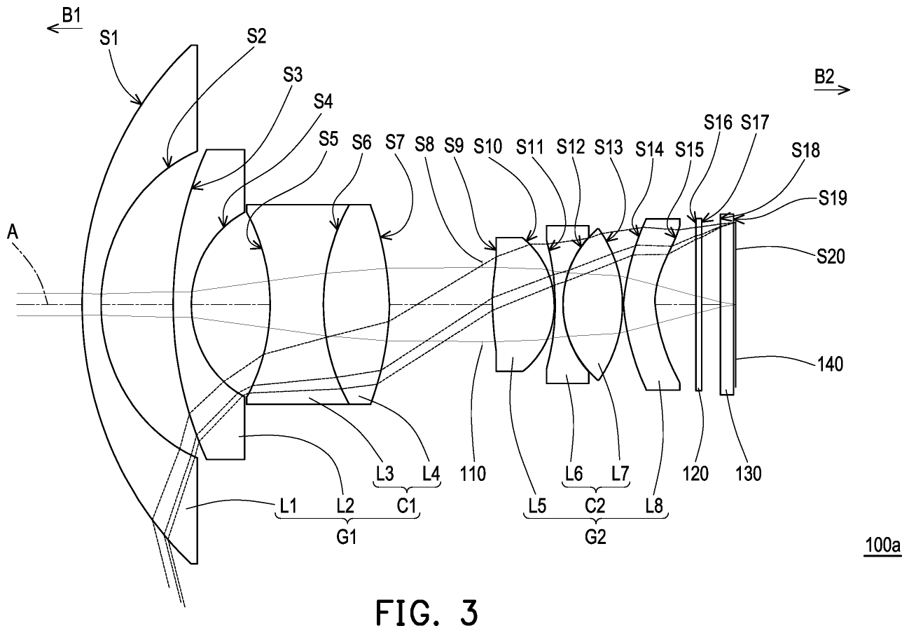

FIG. 3 is a schematic cross-sectional view of a fixed focus image capturing lens according to a second embodiment of the disclosure. Please refer to FIG. 3. A fixed focus image capturing lens 100a of the second embodiment of the disclosure is similar to the fixed focus image capturing lens 100 of FIG. 1, and differences between the two are that the optical data of each element and the parameters such as the spacing between the elements are not exactly the same. The following is a brief description of the differences between the two. In the embodiment, the refractive power of the eighth lens L8 is negative, and the eighth lens L8 is a negative meniscus lens with a convex surface facing the object side B1. In addition, in the embodiment, the at least one aspherical lens includes a lens farthest from the aperture 110 (for example, the eighth lens L8 in the embodiment) in the second lens group G2. In the embodiment, the fourth lens L4, the fifth lens L5, and the eighth lens L8 are aspherical lenses, such as glass molded lenses. In addition, the first to third lenses L1 to L3, the sixth lens L6, and the seventh lens L7 are spherical lenses, such as glass lenses. In the embodiment, the refractive powers of the first to eighth lenses L1 to L8 are negative, negative, negative, positive, positive, negative, positive, and negative.

The following Table 3 lists the parameters of the surfaces of each optical element of the fixed focus image capturing lens 100a of the embodiment:

TABLE 3

| | | | | | Effec- | |
|---|---|---|---|---|---|---|
| | Radius of | | Refrac- | Abbe | tive | |
| Sur- | curvature | Spacing | tive | num- | radius | |
| face | (mm) | (mm) | index | ber | (mm) | Remark |
| S1 | 17.17 | 1.001 | 1.88 | 41 | 12.02 | First lens L1 |
| S2 | 8.21 | 3.824 | | | 7.63 | |
| S3 | 17.48 | 0.963 | 2.10 | 17 | 7.02 | Second lens L2 |
| S4 | 5.11 | 4.177 | | | 4.56 | |
| S5 | −9.07 | 2.831 | 1.50 | 82 | 4.44 | Third lens L3 |
| S6 | 9.63 | 3.500 | 1.82 | 24 | 4.05 | Fourth lens L4 |
| S7 | −11.01 | 4.914 | | | 3.78 | |
| S8 | Infinity | 0.543 | | | 1.84 | Aperture 110 |
| S9 | 9.53 | 3.282 | 1.50 | 81 | 2.24 | Fifth lens L5 |
| S10 | −3.94 | 0.050 | | | 2.91 | |
| S11 | −11.26 | 0.420 | 1.81 | 25 | 2.96 | Sixth lens L6 |
| S12 | 4.76 | 3.152 | 1.59 | 69 | 3.29 | Seventh lens L7 |
| S13 | −6.21 | 0.050 | | | 3.55 | |
| S14 | 5.75 | 1.663 | 1.74 | 49 | 3.95 | Eighth lens L8 |
| S15 | 4.25 | 2.184 | | | 3.89 | |
| S16 | 6.18 | 0.300 | 1.52 | 64 | 4.01 | Infrared cut-off |
| | | | | | | filter 120 |
| S17 | Infinity | 1.000 | | | 4.04 | |
| S18 | Infinity | 0.700 | 1.52 | 64 | 4.18 | Glass cover 130 |
| S19 | Infinity | 0.045 | | | 4.24 | |
| S20 | Infinity | 0.000 | | | 4.25 | Image sensor 140 |

Among the above-mentioned surfaces, the surfaces S7, S9, S10, S14, and S15 are aspherical surfaces, which may be expressed by the aspherical surface equation (that is, Equation (1)). The following Table 4 lists the aspherical parameters of the surfaces S7, S9, S10, S14, and S15 of the fixed focus image capturing lens 100a of the embodiment:

TABLE 4

| Surface | K | a₄ | a₆ | a₈ |
|---|---|---|---|---|
| S7 | 0.00 | 3.05E−04 | −1.60E−06 | 3.83E−08 |
| S9 | 0.00 | −1.49E−03 | −2.70E−04 | 3.21E−05 |
| S10 | 0.00 | 4.08E−03 | −3.91E−04 | 3.74E−05 |
| S14 | 0.50 | −3.24E−04 | −1.62E−04 | 2.77E−06 |
| S15 | −0.67 | −1.99E−04 | −2.19E−04 | 3.85E−06 |

| Surface | a₁₀ | a₁₂ | a₁₄ | a₁₆ |
|---|---|---|---|---|
| S7 | 0.00E+00 | 0.00E+00 | 0.00E+00 | 0.00E+00 |
| S9 | −6.17E−06 | 0.00E+00 | 0.00E+00 | 0.00E+00 |
| S10 | −2.46E−06 | 0.00E+00 | 0.00E+00 | 0.00E+00 |
| S14 | −1.19E−07 | 0.00E+00 | 0.00E+00 | 0.00E+00 |
| S15 | −5.32E−09 | 0.00E+00 | 0.00E+00 | 0.00E+00 |

In the embodiment, the aspherical coefficients a₂ of the surfaces S7, S9, S10, S14, and S15 are all zero.

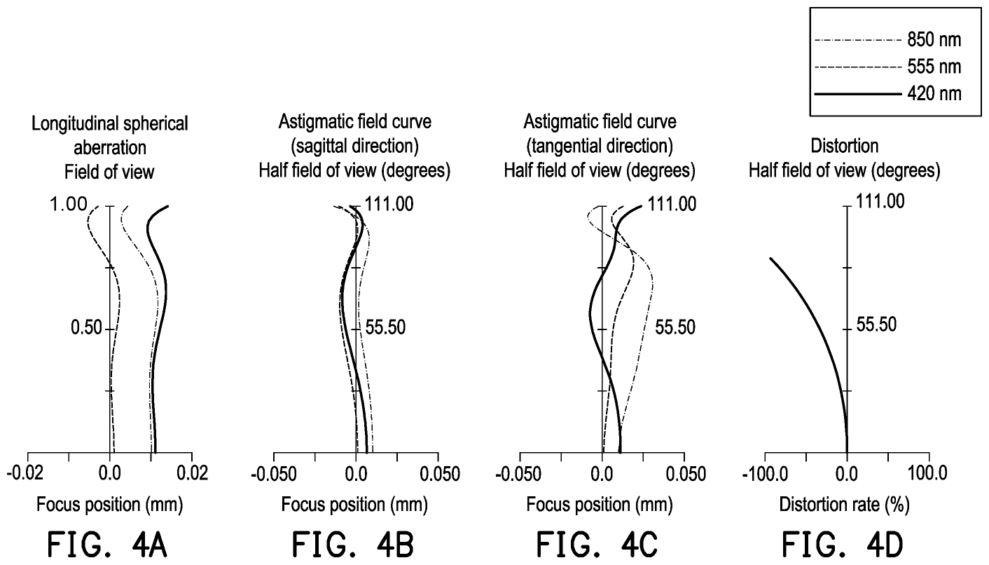

FIG. 4A to FIG. 4D are optical imaging quality graphs of the fixed focus image capturing lens of FIG. 3. FIG. 4A is a longitudinal spherical aberration diagram of the fixed focus image capturing lens 100a, FIG. 4B is an astigmatic field curve in the sagittal direction of the fixed focus image capturing lens 100a, FIG. 4C is an astigmatic field curve in the tangential direction of the fixed focus image capturing lens 100a, and FIG. 4D is a distortion diagram of the fixed focus image capturing lens 100a. The drawings are simulated using imaging rays with wavelengths of 850 nm, 555 nm, and 420 nm. It can be seen from FIG. 4A to FIG. 4D that the imaging quality of the fixed focus image capturing lens 100a is good.

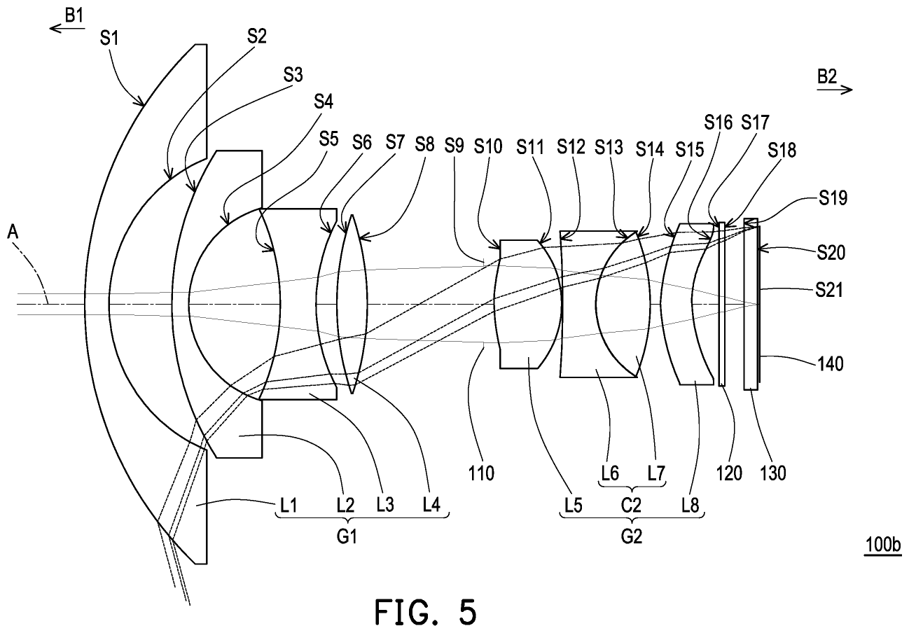

FIG. 5 is a schematic cross-sectional view of a fixed focus image capturing lens according to a third embodiment of the disclosure. Please refer to FIG. 5. A fixed focus image capturing lens 100b of the third embodiment of the disclosure is similar to the fixed focus image capturing lens 100a of FIG. 3, and differences between the two are that the optical data of each element and the parameters such as the spacing between the elements are not exactly the same. The following is a brief description of the differences between the two. In the fixed focus image capturing lens 100b of the embodiment, the fourth lens L4 is a spherical lens, and the third lens L3 and the second lens L4 are respectively two lenses that are not cemented together. In addition, in the embodiment, the fifth lens L5 and the eighth lens L8 are aspherical lenses and are glass molded lenses, and the first to fourth lenses L1 to L4, the sixth lens L6, and the seventh lens L7 are spherical lenses and are glass lenses. In the embodiment, the refractive powers of the first to eighth lenses L1 to L8 are negative, negative, negative, positive, positive, negative, positive, and negative.

The following Table 5 lists the parameters of the surfaces of each optical element of the fixed focus image capturing lens 100b of the embodiment:

TABLE 5

| | | | | | Effec- | |
|---|---|---|---|---|---|---|
| | Radius of | | Refrac- | Abbe | tive | |
| Sur- | curvature | Spacing | tive | num- | radius | |
| face | (mm) | (mm) | index | ber | (mm) | Remark |
| S1 | 18.62 | 1.265 | 1.80 | 47 | 12.66 | First lens L1 |
| S2 | 8.15 | 3.249 | | | 7.58 | |
| S3 | 14.77 | 0.873 | 2.10 | 17 | 7.33 | Second lens L2 |
| S4 | 5.17 | 4.742 | | | 4.76 | |
| S5 | −9.27 | 1.849 | 1.50 | 82 | 4.46 | Third lens L3 |
| S6 | 9.27 | 1.070 | | | 4.01 | |
| S7 | 14.50 | 1.572 | 1.92 | 24 | 4.07 | Fourth lens L4 |
| S8 | −14.50 | 6.042 | | | 4.02 | |
| S9 | Infinity | 0.521 | | | 1.97 | Aperture 110 |
| S10 | 7.47 | 3.500 | 1.50 | 81 | 2.47 | Fifth lens L5 |
| S11 | −4.96 | 0.050 | | | 3.10 | |
| S12 | −39.34 | 1.717 | 1.81 | 23 | 3.15 | Sixth lens L6 |
| S13 | 4.40 | 2.814 | 1.59 | 69 | 3.36 | Seventh lens L7 |
| S14 | −9.84 | 0.522 | | | 3.51 | |
| S15 | 7.73 | 1.625 | 1.51 | 64 | 3.92 | Eighth lens L8 |
| S16 | 6.18 | 1.413 | | | 4.01 | |
| S17 | Infinity | 0.300 | 1.52 | 64 | 4.04 | Infrared cut-off |
| | | | | | | filter 120 |
| S18 | Infinity | 1.000 | | | 4.06 | |
| S19 | Infinity | 0.700 | 1.52 | 64 | 4.14 | Glass cover 130 |
| S20 | Infinity | 0.045 | | | 4.18 | |
| S21 | Infinity | 0.000 | | | 4.18 | Image sensor 140 |

In Table 5, the surfaces S5 and S6 are the two opposite surfaces of the third lens L3, and the surfaces S7 and S8 are the two opposite surfaces of the fourth lens L4.

Among the above-mentioned surfaces, the surfaces S10, S11, S15, and S16 are aspherical surfaces, which may be expressed by the aspherical surface equation (that is, Equation (1)). The following Table 6 lists the aspherical parameters of the surfaces S10, S11, S15, and S16 of the fixed focus image capturing lens 100b of the embodiment:

TABLE 6

| Surface | K | a₄ | a₆ | a₈ |
|---|---|---|---|---|
| S10 | 0.00 | −1.45E−03 | −1.44E−04 | 1.32E−05 |
| S11 | 0.00 | 2.27E−03 | −2.36E−04 | 1.61E−05 |
| S15 | −0.06 | 2.24E−03 | −2.09E−04 | 4.96E−06 |
| S16 | −1.28 | 3.19E−03 | −2.41E−04 | 1.29E−06 |

| Surface | a₁₀ | a₁₂ | a₁₄ | a₁₆ |
|---|---|---|---|---|
| S10 | −2.25E−06 | 0.00E+00 | 0.00E+00 | 0.00E+00 |
| S11 | −1.09E−06 | 0.00E+00 | 0.00E+00 | 0.00E+00 |
| S15 | −1.53E−07 | 0.00E+00 | 0.00E+00 | 0.00E+00 |
| S16 | −3.88E−08 | 0.00E+00 | 0.00E+00 | 0.00E+00 |

In the embodiment, the aspherical coefficients a₂ of the surfaces 510, S11, S15, and S16 are all zero.

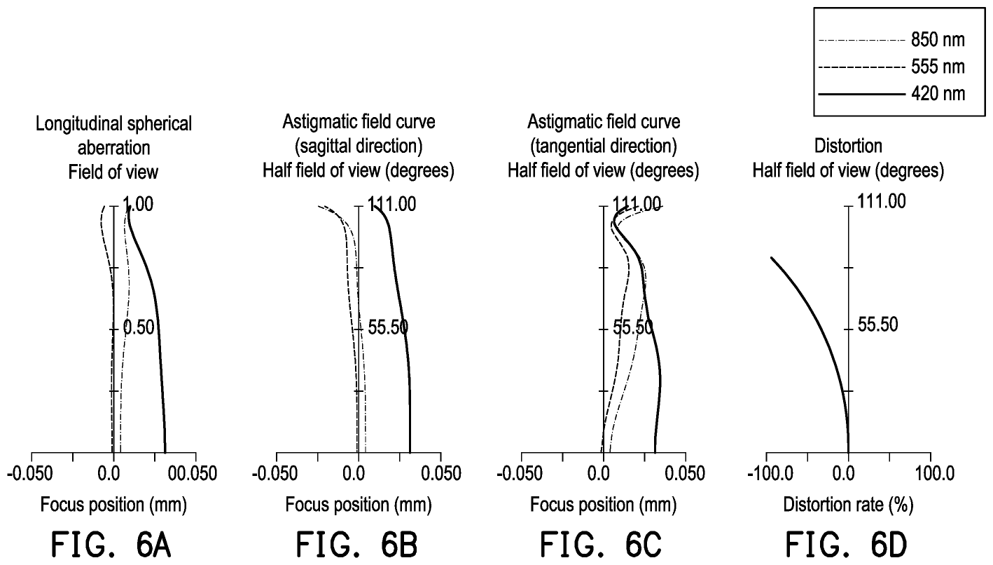

FIG. 6A to FIG. 6D are optical imaging quality graphs of the fixed focus image capturing lens of FIG. 5. FIG. 6A is a longitudinal spherical aberration diagram of the fixed focus image capturing lens 100b, FIG. 6B is an astigmatic field curve in the sagittal direction of the fixed focus image capturing lens 100b, FIG. 6C is an astigmatic field curve in the tangential direction of the fixed focus image capturing lens 100b, and FIG. 6D is a distortion diagram of the fixed focus image capturing lens 100b. The drawings are simulated using imaging rays with wavelengths of 850 nm, 555 nm, and 420 nm. It can be seen from FIG. 6A to FIG. 6D that the imaging quality of the fixed focus image capturing lens 100b is good.

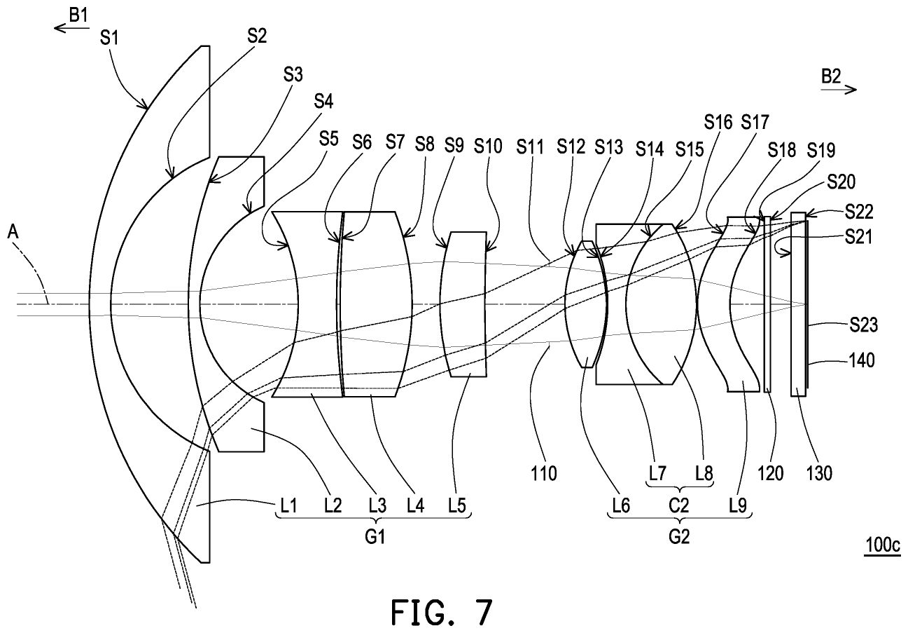

FIG. 7 is a schematic cross-sectional view of a fixed focus image capturing lens according to a fourth embodiment of the disclosure. Please refer to FIG. 7. A fixed focus image capturing lens 100c of the fourth embodiment of the disclosure is similar to the fixed focus image capturing lens 100b of the third embodiment of FIG. 5, and differences between the two are that the number of lenses, the optical data of each element, and the parameters such as the spacing between the elements are not exactly the same. The following is a brief description of the differences between the two. Compared with the first lens group G1 of the fixed focus image capturing lens 100b of the third embodiment having four lenses, that is, the first to fourth lenses L1 to L4, the first lens group G1 of the fixed focus image capturing lens 100c of the fourth embodiment has five lenses, that is, an extra fifth lens L5. In the embodiment, the refractive power of the fifth lens L5 is positive, and the fifth lens L5 is a positive meniscus lens with a convex surface facing the object side B1.

In the embodiment, the number of lenses having refractive power of the fixed focus image capturing lens 100c is 9, the number of lenses having refractive power of the first lens group G1 is 5, and the number of lenses having refractive power of the second lens group G2 is 4. In addition, in the embodiment, the refractive powers of the five lenses (that is, the first to fifth lenses L1 to L5) of the first lens group G1 are negative, negative, negative, positive, and positive in sequence from a side far from the aperture 110 to a side close to the aperture 110, and the refractive powers of the four lenses (that is, the sixth to ninth lenses L6 to L9) of the second lens group G2 are positive, negative, positive, and positive in sequence from a side close to the aperture 110 to a side far from the aperture 110.

In the embodiment, the sixth lens L6 is a biconvex lens, the seventh lens L7 is a biconcave lens, the eighth lens L8 is a biconvex lens, and the ninth lens L9 is a positive meniscus lens with a convex surface facing the object side B1, wherein the seventh lens L7 and the eighth lens L8 form a double cemented lens. In the embodiment, the sixth lens L6 and the ninth lens L9 are aspherical lenses and are glass molded lenses, and the first to fifth lenses L1 to L5, the seventh lens L7, and the eighth lens L8 are spherical lenses and are glass lenses.

The following Table 7 lists the parameters of the surfaces of each optical element of the fixed focus image capturing lens 100c of the embodiment:

TABLE 7

| | | | | | Effec- | |
|---|---|---|---|---|---|---|
| | Radius of | | Refrac- | Abbe | tive | |
| Sur- | curvature | Spacing | tive | num- | radius | |
| face | (mm) | (mm) | index | ber | (mm) | Remark |
| S1 | 17.15 | 1.051 | 1.80 | 47 | 11.69 | First lens L1 |
| S2 | 7.69 | 3.749 | | | 7.14 | |
| S3 | 18.03 | 0.566 | 2.10 | 17 | 6.51 | Second lens L2 |
| S4 | 5.20 | 4.782 | | | 4.51 | |
| S5 | −7.77 | 1.840 | 1.55 | 75 | 3.95 | Third lens L3 |
| S6 | 27.82 | 0.169 | | | 3.91 | |
| S7 | 49.01 | 3.500 | 1.92 | 21 | 3.91 | Fourth lens L4 |
| S8 | −12.37 | 1.340 | | | 3.94 | |
| S9 | 11.65 | 2.172 | 1.88 | 41 | 3.22 | Fifth lens L5 |
| S10 | 51.39 | 3.135 | | | 2.78 | |
| S11 | Infinity | 0.743 | | | 1.82 | Aperture 110 |
| S12 | 6.02 | 2.019 | 1.50 | 81 | 2.86 | Sixth lens L6 |
| S13 | −6.32 | 0.050 | | | 2.93 | |
| S14 | −7.94 | 0.875 | 1.81 | 23 | 2.92 | Seventh lens L7 |
| S15 | 5.09 | 3.431 | 1.59 | 69 | 3.28 | Eighth lens L8 |
| S16 | −6.98 | 0.050 | | | 3.64 | |
| S17 | 4.50 | 1.572 | 1.51 | 64 | 3.98 | Ninth lens L9 |
| S18 | 4.63 | 1.661 | | | 4.02 | |
| S19 | Inf. | 0.300 | 1.52 | 64 | 4.04 | Infrared cut-off |
| | | | | | | filter 120 |
| S20 | Infinity | 1.000 | | | 4.06 | |
| S21 | Infinity | 0.700 | 1.52 | 64 | 4.15 | Glass cover 130 |
| S22 | Infinity | 0.045 | | | 4.20 | |
| S23 | Infinity | 0.000 | | | 4.20 | Image sensor 140 |

In Table 7, the surfaces S9 and S10 are the two opposite surfaces of the fifth lens L5.

Among the above-mentioned surfaces, the surfaces S12, S13, S17, and S18 are aspherical surfaces, which may be expressed by the aspherical surface equation (that is, Equation (1)). The following Table 8 lists the aspherical parameters of the surfaces S12, S13, S17, and S18 of the fixed focus image capturing lens 100c of the embodiment:

TABLE 8

| Surface | K | a₄ | a₆ | a₈ |
|---|---|---|---|---|
| S12 | −0.22 | −9.61E−05 | −2.66E−05 | 4.37E−06 |
| S13 | −2.24 | 0.00E+00 | 0.00E+00 | 0.00E+00 |
| S17 | −2.69 | 2.80E−03 | −1.37E−04 | 6.92E−07 |
| S18 | −2.03 | 2.67E−03 | −1.15E−04 | −8.22E−07 |

| Surface | a₁₀ | a₁₂ | a₁₄ | a₁₆ |
|---|---|---|---|---|
| S12 | −1.37E−07 | 0.00E+00 | 0.00E+00 | 0.00E+00 |
| S13 | 0.00E+00 | 0.00E+00 | 0.00E+00 | 0.00E+00 |
| S17 | −4.83E−08 | −5.54E−09 | 0.00E+00 | 0.00E+00 |
| S18 | −4.02E−07 | 1.28E−08 | 0.00E+00 | 0.00E+00 |

In the embodiment, the aspherical coefficients a₂ of the surfaces S12, S13, S17, and S18 are all zero.

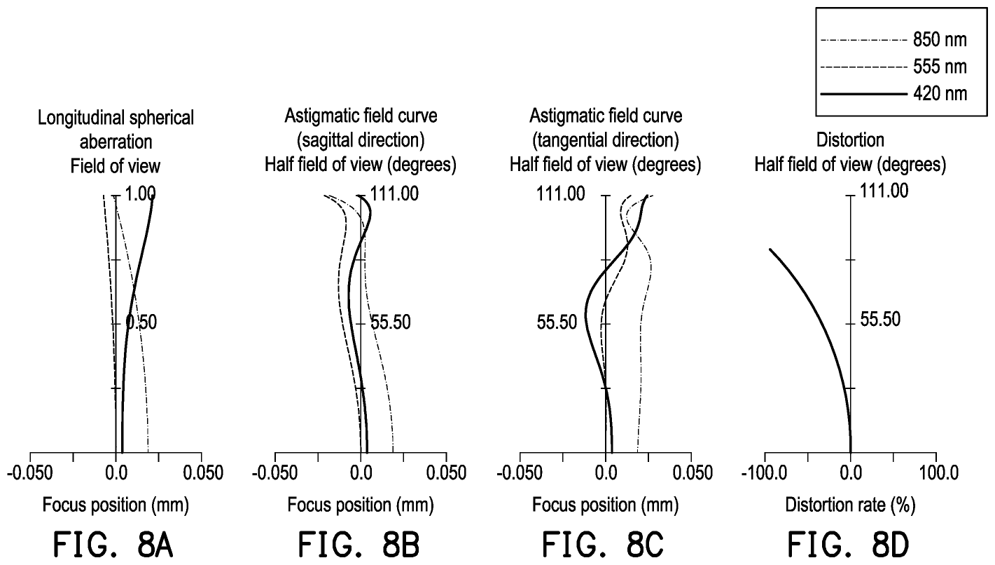

FIG. 8A to FIG. 8D are optical imaging quality graphs of the fixed focus image capturing lens of FIG. 7. FIG. 8A is a longitudinal spherical aberration diagram of the fixed focus image capturing lens 100c, FIG. 8B is an astigmatic field curve in the sagittal direction of the fixed focus image capturing lens 100c, FIG. 8C is an astigmatic field curve in the tangential direction of the fixed focus image capturing lens 100c, and FIG. 8D is a distortion diagram of the fixed focus image capturing lens 100c. The drawings are simulated using imaging rays with wavelengths of 850 nm, 555 nm, and 420 nm. It can be seen from FIG. 8A to FIG. 8D that the imaging quality of the fixed focus image capturing lens 100c is good.

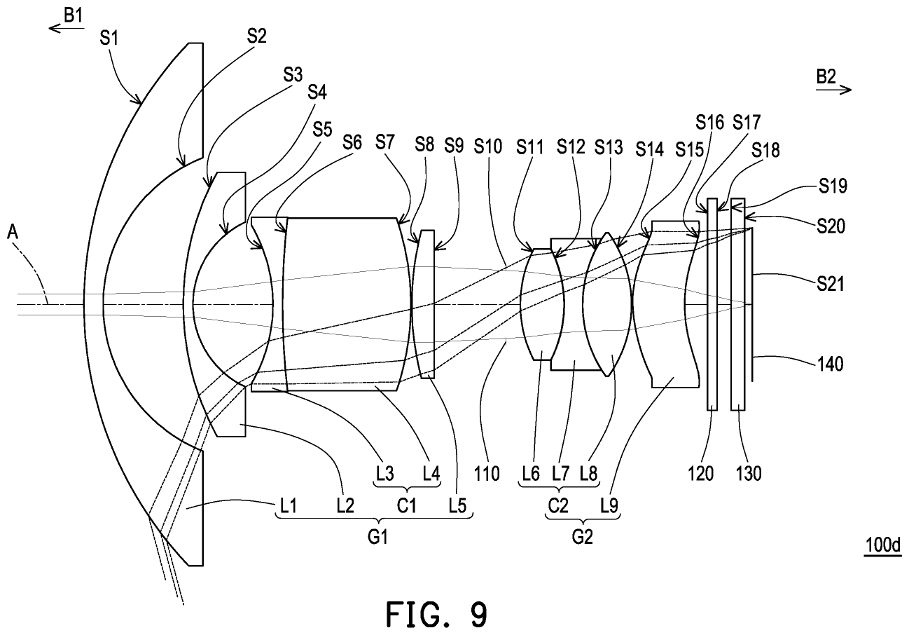

FIG. 9 is a schematic cross-sectional view of a fixed focus image capturing lens according to a fifth embodiment of the disclosure. Please refer to FIG. 9. A fixed focus image capturing lens 100d of the fifth embodiment of the disclosure is similar to the fixed focus image capturing lens 100c of the fourth embodiment of FIG. 7, and differences between the two are that the optical data of each element and the parameters such as the spacing between the elements are not exactly the same. The following is a brief description of the differences between the two. In the fixed focus image capturing lens 100d of the embodiment, the fifth lens L5 is a plano-convex lens with a convex surface facing the object side B1. In addition, the cemented lens of the second lens group G2 is a triple cemented lens. The first lens group G1 has five lenses, and the lenses third farthest and fourth farthest from the aperture 110 (that is, the third lens L3 and the fourth lens L4) form a double cemented lens. Specifically, the third lens L3 and the fourth lens L4 form a double cemented lens (that is, the cemented lens C1), and the sixth lens L6, the seventh lens L7, and the eighth lens L8 form a triple cemented lens (that is, the cemented lens C2). In addition, in the embodiment, the ninth lens L9 is an aspherical lens and is a glass molded lens, and the first to eighth lenses L1 to L8 are spherical lenses and are glass lenses. In the embodiment, the refractive powers of the first to ninth lenses L1 to L9 are negative, negative, negative, positive, positive, positive, negative, positive, and positive.

In the embodiment, the ratio of the total thickness of the triple cemented lens (that is, the cemented lens C2) to LT on the optical axis A falls within the range of 0.06 to 0.28, where LT is the distance between the outermost lens surfaces on the two sides of the fixed focus image capturing lens 100d on the optical axis A (that is, the distance between the surface S1 and the surface S16 on the optical axis A in the embodiment), wherein the ratio of the total thickness of the triple cemented lens (that is, the cemented lens C2) to LT on the optical axis A may fall within the range of 0.062 to 0.278 in an embodiment, and may fall within the range of 0.064 to 0.276 in another embodiment.

The fixed focus image capturing lens 100d of the embodiment may be applicable to light from 420 nm to 940 nm, that is, the focus is still clear even when the long wavelength in the day and night confocal is extended to 940 nm.

The following Table 9 lists the parameters of the surfaces of each optical element of the fixed focus image capturing lens 100d of the embodiment:

TABLE 9

| | | | | | Effec- | |
|---|---|---|---|---|---|---|
| | Radius of | | Refrac- | Abbe | tive | |
| Sur- | curvature | Spacing | tive | num- | radius | |
| face | (mm) | (mm) | index | ber | (mm) | Remark |
| S1 | 19.64 | 1.000 | 1.80 | 47 | 12.50 | First lens L1 |
| S2 | 8.19 | 4.161 | | | 7.62 | |
| S3 | 14.22 | 0.500 | 1.99 | 16 | 6.23 | Second lens L2 |
| S4 | 4.72 | 4.154 | | | 4.28 | |
| S5 | −8.13 | 0.501 | 1.62 | 63 | 4.12 | Third lens L3 |
| S6 | 39.20 | 6.661 | 1.92 | 24 | 4.07 | Fourth lens L4 |
| S7 | −13.77 | 0.050 | | | 3.86 | |
| S8 | 14.82 | 1.166 | 1.92 | 24 | 3.49 | Fifth lens L5 |
| S9 | Infinity | 3.726 | | | 3.26 | |
| S10 | Infinity | 0.753 | | | 1.76 | Aperture 110 |
| S11 | 6.37 | 2.271 | 1.50 | 82 | 2.42 | Sixth lens L6 |
| S12 | −6.37 | 0.956 | 1.81 | 23 | 2.62 | Seventh lens L7 |
| S13 | 6.37 | 2.538 | 1.55 | 75 | 3.10 | Eighth lens L8 |
| S14 | −6.37 | 0.050 | | | 3.37 | |
| S15 | 6.08 | 2.712 | 1.77 | 50 | 3.84 | Ninth lens L9 |
| S16 | 7.48 | 1.186 | | | 3.90 | |
| S17 | Infinity | 0.500 | 1.52 | 64 | 3.94 | Infrared cut-off |
| | | | | | | filter 120 |
| S18 | Infinity | 0.722 | | | 3.97 | |
| S19 | Infinity | 0.700 | 1.52 | 64 | 4.03 | Glass cover 130 |
| S20 | Infinity | 0.400 | | | 4.07 | |
| S21 | Infinity | 0.000 | | | 4.11 | Image sensor 140 |

In Table 9, the surface S5 is the surface of the third lens L3 facing the object side B1, the surface S6 is the surface connecting the third lens L3 and the fourth lens L4, and the surface S7 is the surface of the fourth lens L4 facing the image side B2. The surface S11 is the surface of the sixth lens L6 facing the object side B1, the surface S12 is the surface connecting the sixth lens L6 and the seventh lens L7, the surface S13 is the surface connecting the seventh lens L7 and the eighth lens L8, and the surface S14 is the surface of the eighth lens L8 facing the image side B2.

Among the above-mentioned surfaces, the surfaces S15 and S16 are aspherical surfaces, which may be expressed by the aspherical surface equation (that is, Equation (1)). The following Table 10 lists the aspherical parameters of the surfaces S15 and S16 of the fixed focus image capturing lens 100d of the embodiment:

TABLE 10

| Surface | K | a₄ | a₆ | a₈ |
|---|---|---|---|---|
| S15 | −3.40 | 1.04E−03 | −3.86E−05 | −3.97E−06 |
| S16 | −0.09 | −1.44E−04 | −5.10E−05 | −1.77E−06 |

| Surface | a₁₀ | a₁₂ | a₁₄ | a₁₆ |
|---|---|---|---|---|
| S15 | 3.14E−07 | −1.35E−08 | 0.00E+00 | 0.00E+00 |
| S16 | −1.04E−07 | 4.84E−09 | 0.00E+00 | 0.00E+00 |

In the embodiment, the aspherical coefficients a₂ of the surfaces S15 and S16 are both zero.

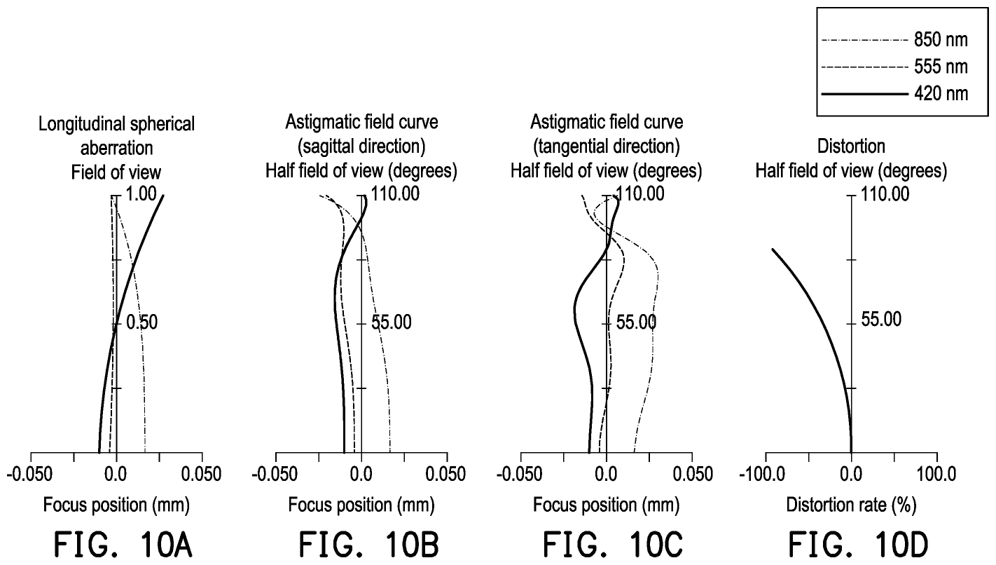

FIG. 10A to FIG. 10D are optical imaging quality graphs of the fixed focus image capturing lens of FIG. 9. FIG. 10A is a longitudinal spherical aberration diagram of the fixed focus image capturing lens 100d, FIG. 10B is an astigmatic field curve in the sagittal direction of the fixed focus image capturing lens 100d, FIG. 10C is an astigmatic field curve in the tangential direction of the fixed focus image capturing lens 100d, and FIG. 10D is a distortion diagram of the fixed focus image capturing lens 100d. The drawings are simulated using imaging rays with wavelengths of 850 nm, 555 nm, and 420 nm. It can be seen from FIG. 10A to FIG. 10D that the imaging quality of the fixed focus image capturing lens 100d is good.

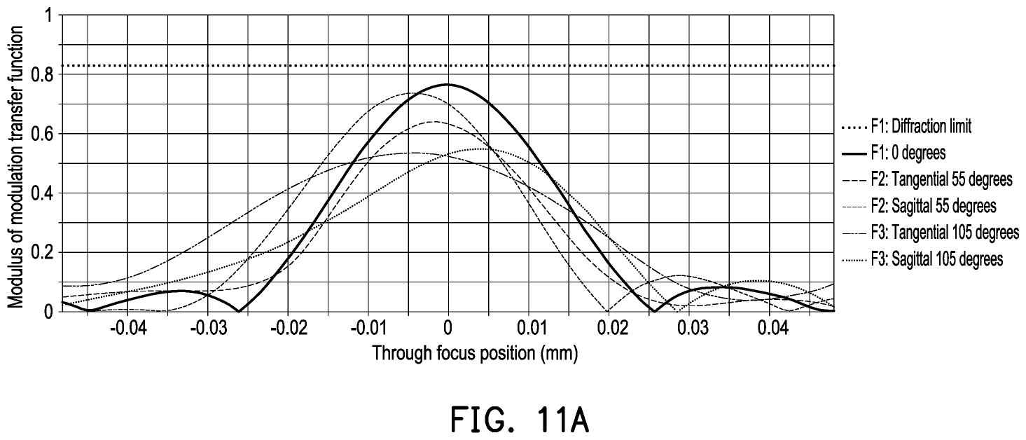

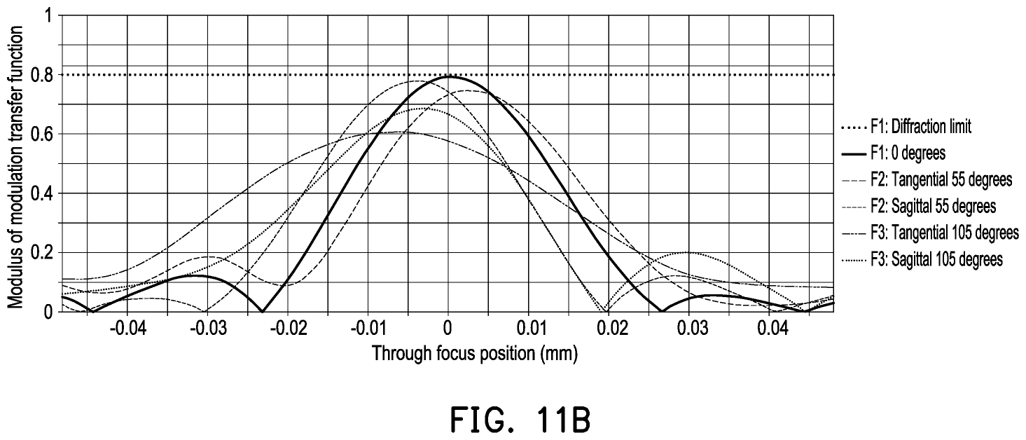

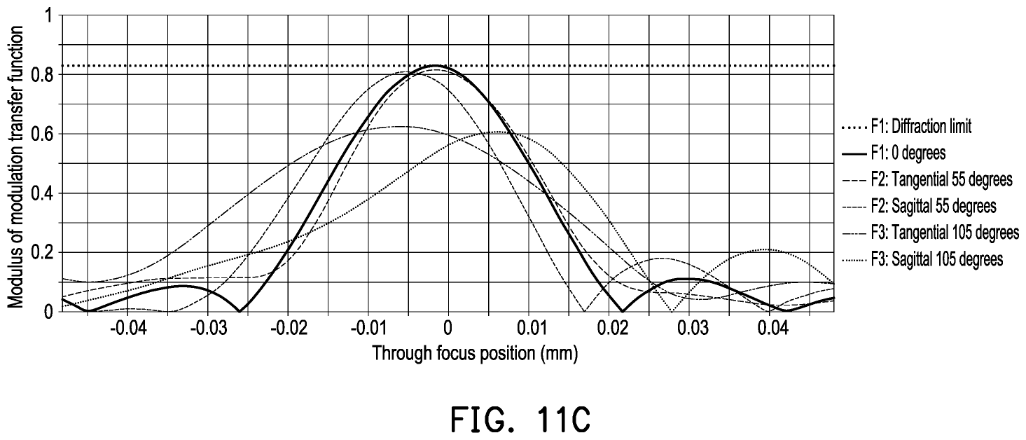

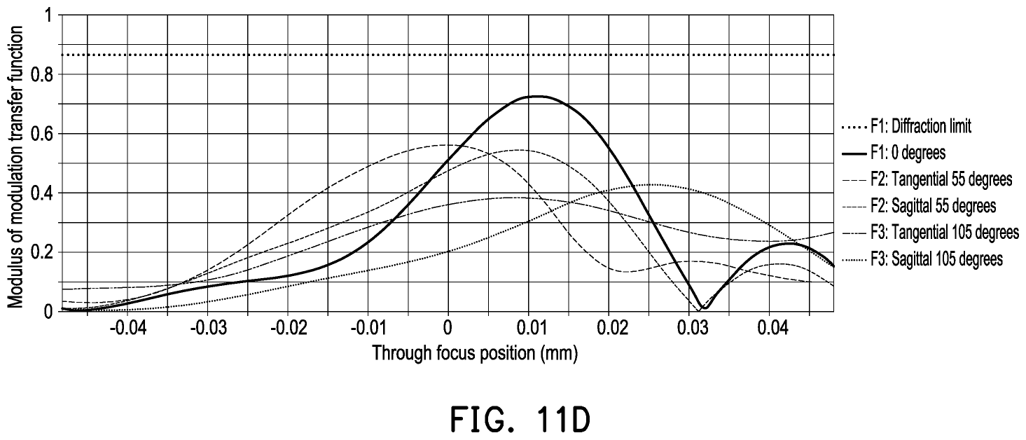

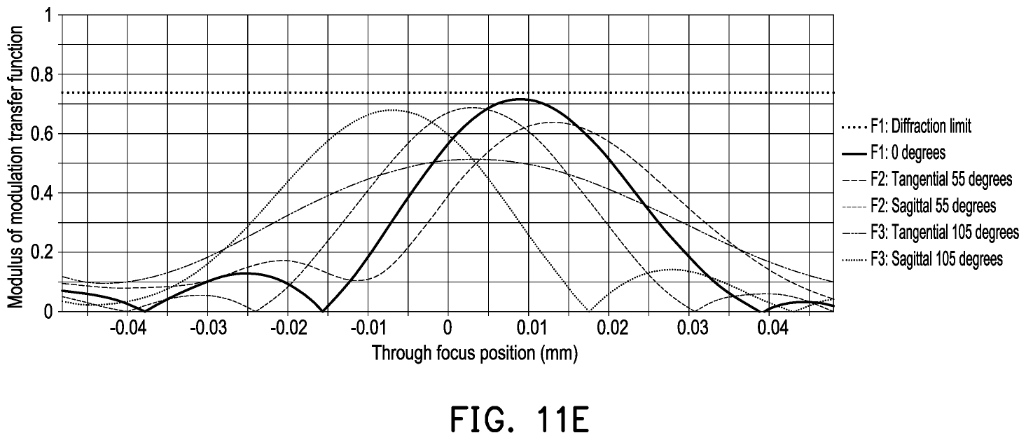

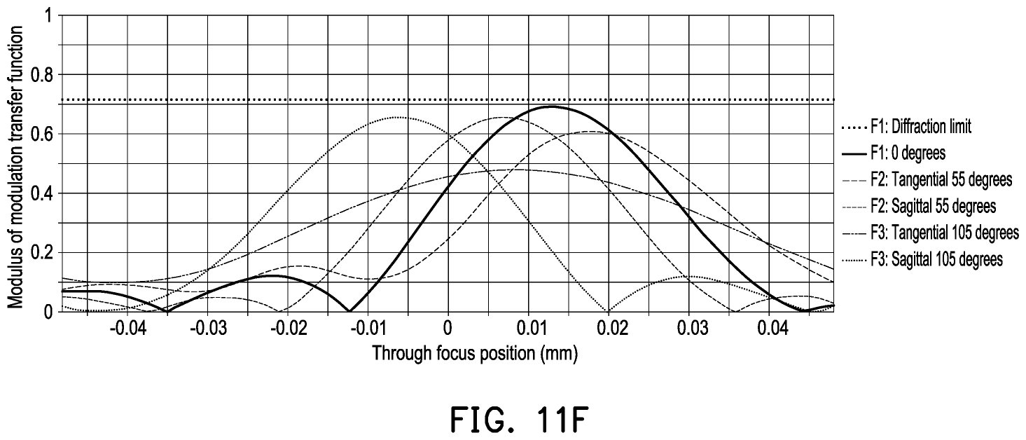

FIG. 11A to FIG. 11F are respectively through focus modulation transfer function (MTF) graphs of the fixed focus image capturing lens of FIG. 9 under visible light (420 nm to 650 nm), red light (650 nm), green light (550 nm), blue light (420 nm), infrared light (850 nm), and infrared light (940 nm) at a spatial frequency of 120 line pairs/millimeter (lp/mm). Please refer to FIG. 11A to FIG. 11F. In the drawings, “F1: Diffraction limit” represents the through focus modulation transfer function curve at the diffraction limit, “F1: 0 degrees” represents the through focus modulation transfer function curve at a field of view of 0 degrees, “F2: Tangential 55 degrees” represents the through focus modulation transfer function curve of rays in the tangential direction at a field of view of 55 degrees, “F2: Sagittal 55 degrees” represents the through focus modulation transfer function curve of rays in the sagittal direction at the field of view of 55 degrees, “F3: Tangential 105 degrees” represents the through focus modulation transfer function curve of rays in the tangential direction at a field of view of 105 degrees, and “F3: Sagittal 105 degrees” represents the through focus modulation transfer function curve of rays in the sagittal direction at the field of view of 105 degrees. In the embodiment, the modulation transfer function of the fixed focus image capturing lens 100d is greater than 40% at the spatial frequency of 120 lp/mm and the wavelength of 420 nm to 850 nm, which may ensure that clear imaging can be provided at all wavelengths, which can be well applied, for example, to a system not monitored by the human eye, such as autonomous driving. In addition, in an embodiment, the modulation transfer function of the fixed focus image capturing lens 100d is greater than 40% at the spatial frequency of 120 lp/mm and the wavelength of 420 nm to 940 nm.

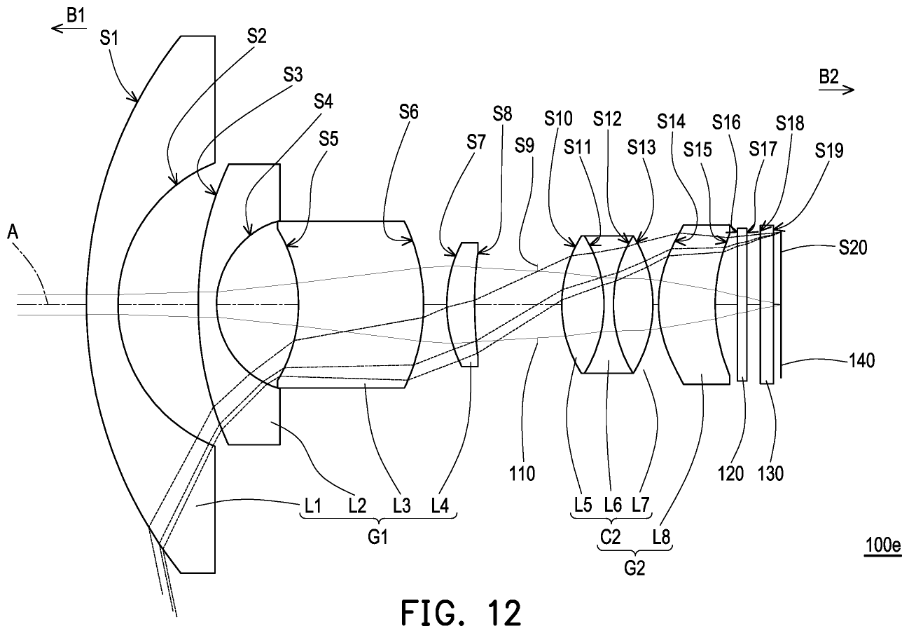

FIG. 12 is a schematic cross-sectional view of a fixed focus image capturing lens according to a sixth embodiment of the disclosure. Please refer to FIG. 12. A fixed focus image capturing lens 100e of the sixth embodiment of the disclosure is similar to the fixed focus image capturing lens 100 of FIG. 1, and differences between the two are that the optical data of each element and the parameters such as the spacing between the elements are not exactly the same. The following is a brief description of the differences between the two. In the fixed focus image capturing lens 100e of the embodiment, the third lens L3 is a negative meniscus lens with a convex surface facing the image side B2, and the fourth lens L4 is a positive meniscus lens with a convex surface facing the object side B1, wherein the third lens L3 and the fourth lens L4 are two separate lenses. The fifth lens L5, the sixth lens L6, and the seventh lens L7 form a triple cemented lens.

In the embodiment, in the fixed focus image capturing lens 100e, the number of lenses made of plastic material is at most 3. In addition, in the embodiment, the lens made of plastic material is located in the first lens group G1, but is not the lens farthest from the aperture (that is, the lens closest to the object side B1, that is, the first lens L1) in the first lens group G1. The first lens L1 is not made of plastic material. Specifically, in the embodiment, the second lens L2 and the fourth lens L4 are plastic lenses and are aspherical lenses. In addition, the eighth lens L8 is a glass molded lens and is also an aspherical lens. In addition, the first lens L1, the third lens L3, the fifth lens L5, the sixth lens L6, and the seventh lens L7 are spherical lenses and are glass lenses. In the embodiment, the refractive powers of the first to ninth lenses L1 to L9 are negative, negative, negative, positive, positive, positive, negative, positive, and positive.

The following Table 11 lists the parameters of the surfaces of each optical element of the fixed focus image capturing lens 100e of the embodiment:

TABLE 11

| | | | | | Effec- | |
|---|---|---|---|---|---|---|
| | Radius of | | Refrac- | Abbe | tive | |
| Sur- | curvature | Spacing | tive | num- | radius | |
| face | (mm) | (mm) | index | ber | (mm) | Remark |
| S1 | 23.39 | 1.679 | 1.83 | 43 | 13.53 | First lens L1 |
| S2 | 8.24 | 4.287 | | | 7.66 | |
| S3 | 19.43 | 0.972 | 1.64 | 24 | 6.89 | Second lens L2 |
| S4 | 4.64 | 4.391 | | | 4.31 | |
| S5 | −8.03 | 6.680 | 1.90 | 31 | 3.90 | Third lens L3 |
| S6 | −10.36 | 1.243 | | | 4.10 | |
| S7 | 7.85 | 1.487 | 1.64 | 24 | 3.20 | Fourth lens L4 |
| S8 | 28.02 | 3.346 | | | 2.88 | |
| S9 | Infinity | 1.309 | | | 1.82 | Aperture 110 |
| S10 | 7.09 | 2.258 | 1.50 | 82 | 2.71 | Fifth lens L5 |
| S11 | −7.09 | 0.500 | 1.85 | 24 | 2.86 | Sixth lens L6 |
| S12 | 7.09 | 2.112 | 1.55 | 75 | 3.20 | Seventh lens L7 |
| S13 | −7.09 | 0.300 | | | 3.37 | |
| S14 | 6.53 | 3.030 | 1.77 | 50 | 3.96 | Eighth lens L8 |
| S15 | 9.96 | 1.191 | | | 3.72 | |
| S16 | Infinity | 0.500 | 1.52 | 64 | 3.79 | Infrared cut-off |
| | | | | | | filter 120 |
| S17 | Infinity | 0.724 | | | 3.83 | |
| S18 | Infinity | 0.700 | 1.52 | 64 | 3.93 | Glass cover 130 |
| S19 | Infinity | 0.400 | | | 4.00 | |
| S20 | Infinity | 0.000 | | | 4.05 | Image sensor 140 |

In Table 11, the surfaces S5 and S6 are the two opposite surfaces of the third lens L3, and the surfaces S7 and S8 are the two opposite surfaces of the fourth lens L4. The surface S10 is the surface of the fifth lens L5 facing the object side B1, the surface S11 is the surface connecting the fifth lens L5 and the sixth lens L6, the surface S12 is the surface connecting the sixth lens L6 and the seventh lens L7, and the surface S13 is the surface of the seventh lens L7 facing the image side B2.

Among the above-mentioned surfaces, the surfaces S3, S4, S7, S8, S14, and S15 are aspherical surfaces, which may be expressed by the aspherical surface equation (that is, Equation (1)). The following Table 12 lists the aspherical parameters of the surfaces S3, S4, S7, S8, S14, and S15 of the fixed focus image capturing lens 100e of the embodiment:

TABLE 12

| Surface | K | a₄ | a₆ | a₈ |
|---|---|---|---|---|
| S3 | 0.00 | −6.51E−05 | 1.54E−06 | 8.48E−09 |
| S4 | 0.00 | −2.82E−04 | −1.16E−05 | 4.02E−07 |
| S7 | 0.00 | 1.88E−04 | 1.60E−05 | 1.97E−07 |
| S8 | 0.00 | 4.33E−04 | 2.74E−05 | −6.53E−07 |
| S14 | 3.95 | −1.98E+00 | 6.40E−02 | −1.21E−02 |
| S15 | 3.71 | 2.68E+00 | −6.82E−02 | −1.64E−02 |

| Surface | a₁₀ | a₁₂ | a₁₄ | a₁₆ |
|---|---|---|---|---|
| S3 | −1.27E−10 | 0.00E+00 | 0.00E+00 | 0.00E+00 |
| S4 | −2.63E−08 | 0.00E+00 | 0.00E+00 | 0.00E+00 |
| S7 | 0.00E+00 | 0.00E+00 | 0.00E+00 | 0.00E+00 |
| S8 | 0.00E+00 | 0.00E+00 | 0.00E+00 | 0.00E+00 |
| S14 | −5.24E−04 | −2.68E−04 | −4.75E−05 | 0.00E+00 |
| S15 | 6.80E−04 | −1.61E−04 | −9.30E−05 | 0.00E+00 |

In the embodiment, the aspherical coefficients a₂ of the surfaces S3, S4, S7, S8, S14, and S15 are all zero.

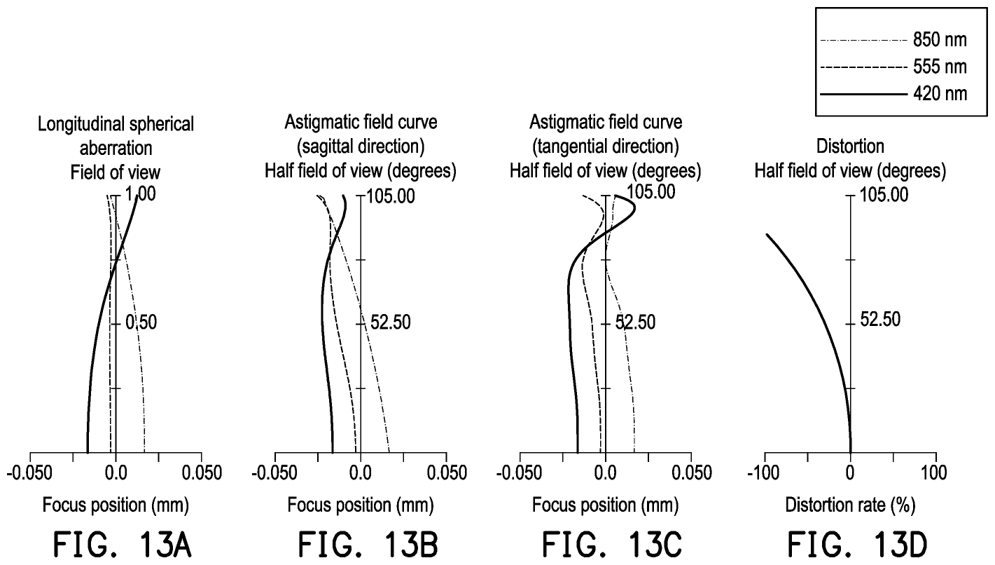

FIG. 13A to FIG. 13D are optical imaging quality graphs of the fixed focus image capturing lens of FIG. 12. FIG. 13A is a longitudinal spherical aberration diagram of the fixed focus image capturing lens 100e, FIG. 13B is an astigmatic field curve in the sagittal direction of the fixed focus image capturing lens 100e, FIG. 13C is an astigmatic field curve in the tangential direction of the fixed focus image capturing lens 100e, and FIG. 13D is a distortion diagram of the fixed focus image capturing lens 100e. The drawings are simulated using imaging rays with wavelengths of 850 nm, 555 nm and 420 nm. It can be seen from FIG. 13A to FIG. 13D that the imaging quality of the fixed focus image capturing lens 100e is good.

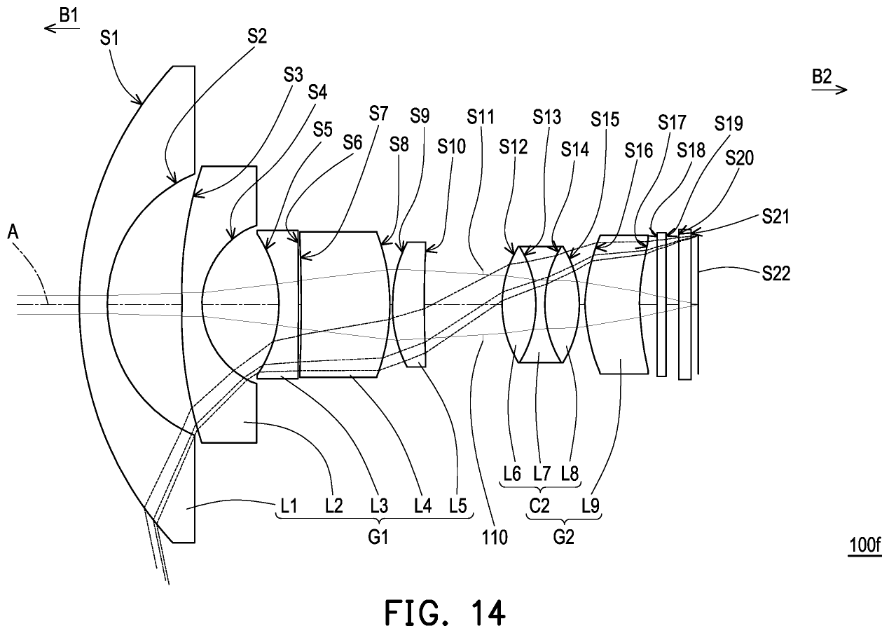

FIG. 14 is a schematic cross-sectional view of a fixed focus image capturing lens according to a seventh embodiment of the disclosure. Please refer to FIG. 14. A fixed focus image capturing lens 100f of the seventh embodiment of the disclosure is similar to the fixed focus image capturing lens 100e of FIG. 12, and differences between the two are that the number of lenses, the optical data of each element, and the parameters such as the spacing between the elements are not exactly the same. The following is a brief description of the differences between the two. In the fixed focus image capturing lens 100f of the embodiment, the third lens L3 in the fixed focus image capturing lens 100e of FIG. 12 is replaced by the third lens L3 and the fourth lens L4. In the embodiment, the above-mentioned aspherical lens includes the lens third farthest from the aperture 110 (that is, the third lens L3) in the first lens group G1. Specifically, in the embodiment, the second lens L2, the third lens L3, and the fifth lens L5 are all plastic lenses and are all aspherical lenses. In addition, the ninth lens L9 is a glass molded lens and is an aspherical lens. In addition, the first lens L1, the fourth lens L4, and the sixth to eighth lenses L6 to L8 are spherical lenses and are glass lenses.

In addition, the refractive power of the third lens L3 is negative, and the third lens L3 is a negative meniscus lens with a convex surface facing toward the image side B2. The refractive power of the fourth lens L4 is positive, and the fourth lens L4 is a positive meniscus lens with a convex surface facing the image side B2. In the embodiment, the refractive powers of the first to ninth lenses L1 to L9 are negative, negative, negative, positive, positive, positive, negative, positive, and positive.

The following Table 13 lists the parameters of the surfaces of each optical element of the fixed focus image capturing lens 100f of the embodiment:

TABLE 13

| | | | | | Effec- | |
|---|---|---|---|---|---|---|
| | Radius of | | Refrac- | Abbe | tive | |
| Sur- | curvature | Spacing | tive | num- | radius | |
| face | (mm) | (mm) | index | ber | (mm) | Remark |
| S1 | 19.90 | 1.584 | 1.88 | 41 | 12.43 | First lens L1 |
| S2 | 8.03 | 4.211 | | | 7.41 | |
| S3 | 42.52 | 1.122 | 1.64 | 24 | 7.12 | Second lens L2 |
| S4 | 4.63 | 4.343 | | | 4.26 | |
| S5 | −6.97 | 1.092 | 1.64 | 24 | 3.82 | Third lens L3 |
| S6 | −122.31 | 0.160 | | | 3.75 | |
| S7 | −90.00 | 4.999 | 1.92 | 24 | 3.75 | Fourth lens L4 |
| S8 | −11.69 | 0.143 | | | 3.73 | |
| S9 | 8.38 | 1.795 | 1.64 | 24 | 3.21 | Fifth lens L5 |
| S10 | 115.12 | 3.318 | | | 2.74 | |
| S11 | Infinity | 1.062 | | | 1.71 | Aperture 110 |
| S12 | 6.32 | 1.914 | 1.50 | 82 | 2.28 | Sixth lens L6 |
| S13 | −6.32 | 0.500 | 1.85 | 24 | 2.44 | Seventh lens L7 |
| S14 | 6.32 | 1.956 | 1.55 | 75 | 2.77 | Eighth lens L8 |
| S15 | −6.32 | 0.300 | | | 2.99 | |
| S16 | 7.17 | 3.084 | 1.77 | 50 | 3.53 | Ninth lens L9 |
| S17 | 11.20 | 0.993 | | | 3.57 | |
| S18 | Infinity | 0.500 | 1.52 | 64 | 3.65 | Infrared cut-off |
| | | | | | | filter 120 |
| S19 | Infinity | 0.722 | | | 3.69 | |
| S20 | Infinity | 0.700 | 1.52 | 64 | 3.80 | Glass cover 130 |
| S21 | Infinity | 0.400 | | | 3.86 | |
| S22 | Infinity | 0.000 | | | 3.92 | Image sensor 140 |

In Table 13, the surfaces S5 and S6 are the two opposite surfaces of the third lens L3, the surfaces S7 and S8 are the two opposite surfaces of the fourth lens L4, and the surfaces S9 and S10 are the two opposite surfaces of the fifth lens L5. The surface S12 is the surface of the sixth lens L6 facing the object side B1, the surface S13 is the surface connecting the sixth lens L6 and the seventh lens L7, the surface S14 is the surface connecting the seventh lens L7 and the eighth lens L8, and the surface S15 is the surface of the eighth lens L8 facing the image side B2, wherein the sixth lens L6, the seventh lens L7, and the eighth lens L8 form a triple cemented lens.

Among the above-mentioned surfaces, the surfaces S3, S4, S5, S6, S9, S10, S16, and S17 are aspherical surfaces, which may be expressed by the aspherical surface equation (that is, Equation (1)). The following Table 14 lists the aspherical parameters of the surfaces S3, S4, S5, S6, S9, S10, S16, and S17 of the fixed focus image capturing lens 100f of the embodiment:

TABLE 14

| Surface | K | a₄ | a₆ | a₈ |
|---|---|---|---|---|
| S3 | 0.00 | 6.51E−05 | 4.48E−07 | 2.73E−09 |
| S4 | 0.00 | −4.66E−04 | −1.64E−05 | 6.84E−07 |
| S5 | 0.00 | −1.12E−04 | 1.56E−05 | −5.13E−08 |
| S6 | 0.00 | 2.21E−04 | −2.61E−06 | 7.70E−08 |
| S9 | 0.00 | 2.39E−04 | 4.20E−06 | 1.90E−08 |
| S10 | 0.00 | 0.00 | 6.82E−06 | −3.58E−07 |
| S16 | −3.41 | 4.30E−04 | −4.55E−05 | 1.13E−06 |
| S17 | 1.06 | 7.62E−06 | −8.26E−05 | 2.06E−06 |

| Surface | a₁₀ | a₁₂ | a₁₄ | a₁₆ |
|---|---|---|---|---|
| S3 | 8.10E−12 | 0.00E+00 | 0.00E+00 | 0.00E+00 |
| S4 | −5.02E−08 | 0.00E+00 | 0.00E+00 | 0.00E+00 |
| S5 | 0.00E+00 | 0.00E+00 | 0.00E+00 | 0.00E+00 |
| S6 | 0.00E+00 | 0.00E+00 | 0.00E+00 | 0.00E+00 |
| S9 | 0.00E+00 | 0.00E+00 | 0.00E+00 | 0.00E+00 |
| S10 | 0.00E+00 | 0.00E+00 | 0.00E+00 | 0.00E+00 |
| S16 | −1.23E−07 | 3.42E−09 | 0.00E+00 | 0.00E+00 |
| S17 | −1.30E−07 | 5.01E−09 | 0.00E+00 | 0.00E+00 |

In the embodiment, the aspherical coefficients a₂ of the surfaces S3, S4, S5, S6, S9, S10, S16, and S17 are all zero.

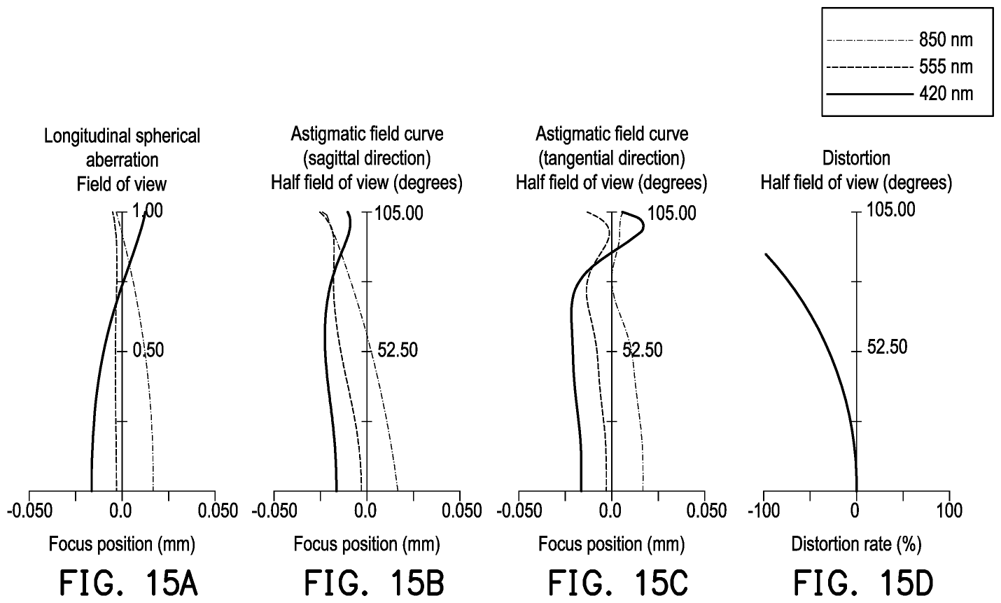

FIG. 15A to FIG. 15D are optical imaging quality graphs of the fixed focus image capturing lens of FIG. 14. FIG. 15A is a longitudinal spherical aberration diagram of the fixed focus image capturing lens 100f, FIG. 15B is an astigmatic field curve in the sagittal direction of the fixed focus image capturing lens 100f, FIG. 15C is an astigmatic field curve in the tangential direction of the fixed focus image capturing lens 100f, and FIG. 15D is a distortion diagram of the fixed focus image capturing lens 100f. The drawings are simulated using imaging rays with wavelengths of 850 nm, 555 nm, and 420 nm. It can be seen from FIG. 15A to FIG. 15D that the imaging quality of the fixed focus image capturing lens 100f is good.

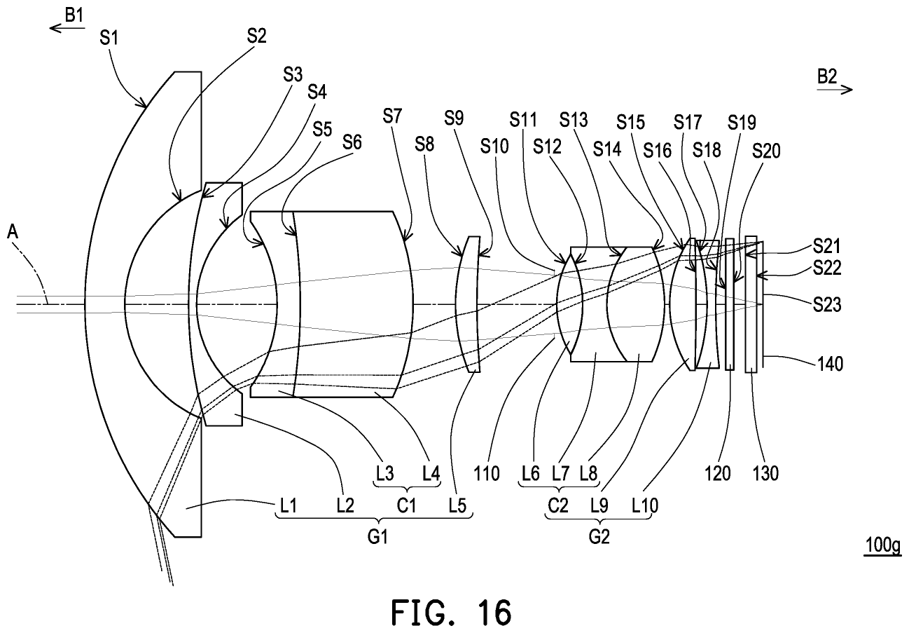

FIG. 16 is a schematic cross-sectional view of a fixed focus image capturing lens according to an eighth embodiment of the disclosure. Please refer to FIG. 16. A fixed focus image capturing lens 100g of the eighth embodiment of the disclosure is similar to the fixed focus image capturing lens 100f of FIG. 14, and differences between the two are that the number of lenses, the optical data of each element, and the parameters such as the spacing between the elements are not exactly the same. The following is a brief description of the differences between the two. In the fixed focus image capturing lens 100g of the embodiment, the third lens L3 and the fourth lens L4 form the cemented lens C1, that is, a double cemented lens. In addition, the ninth lens L9 is a biconvex lens. The second lens group G2 further includes a tenth lens L10, which is disposed between the ninth lens L9 and the image side B2. The refractive power of the tenth lens L10 is negative, and the tenth lens L10 is, for example, a biconcave lens. In the embodiment, the first to tenth lenses L1 to L10 are all spherical lenses and are all glass lenses. In the embodiment, the refractive powers of the first to tenth lenses L1 to L10 are negative, negative, negative, positive, positive, positive, negative, positive, positive, and negative. In the embodiment, the surface (that is, the surface S6) of the lens third farthest from the aperture 110 (that is, the third lens L3) facing the aperture 110 is convex.

The following Table 15 lists the parameters of the surfaces of each optical element of the fixed focus image capturing lens 100g of the embodiment:

TABLE 15

| | | | | | Effec- | |
|---|---|---|---|---|---|---|
| | Radius of | | Refrac- | Abbe | tive | |
| Sur- | curvature | Spacing | tive | num- | radius | |
| face | (mm) | (mm) | index | ber | (mm) | Remark |
| S1 | 21.47 | 2.486 | 1.83 | 43 | 13.47 | First lens L1 |
| S2 | 7.67 | 3.957 | | | 7.09 | |
| S3 | 26.63 | 0.500 | 2.10 | 17 | 6.86 | Second lens L2 |
| S4 | 6.88 | 5.003 | | | 5.29 | |
| S5 | −8.82 | 1.443 | 1.52 | 64 | 4.90 | Third lens L3 |
| S6 | −36.34 | 7.000 | 1.92 | 24 | 4.95 | Fourth lens L4 |
| S7 | −13.86 | 2.639 | | | 5.24 | |
| S8 | 11.07 | 1.327 | 1.92 | 24 | 3.87 | Fifth lens L5 |
| S9 | 37.93 | 4.817 | | | 3.60 | |
| S10 | Infinity | 0.122 | | | 1.82 | Aperture 110 |
| S11 | 6.05 | 1.636 | 1.50 | 82 | 1.93 | Sixth lens L6 |
| S12 | −6.93 | 1.497 | 1.85 | 24 | 2.08 | Seventh lens L7 |
| S13 | 5.69 | 3.591 | 1.55 | 75 | 2.50 | Eighth lens L8 |
| S14 | −8.49 | 0.300 | | | 3.26 | |
| S15 | 7.28 | 1.639 | 1.88 | 41 | 3.80 | Ninth lens L9 |
| S16 | −140.30 | 0.698 | | | 3.72 | |
| S17 | −10.98 | 0.528 | 1.92 | 24 | 3.68 | Tenth lens L10 |
| S18 | 34.73 | 0.624 | | | 3.70 | |
| S19 | Infinity | 0.500 | 1.52 | 64 | 3.76 | Infrared cut-off |
| | | | | | | filter 120 |
| S20 | Infinity | 0.724 | | | 3.80 | |
| S21 | Infinity | 0.700 | 1.52 | 64 | 3.90 | Glass cover 130 |
| S22 | Infinity | 0.400 | | | 3.96 | |
| S23 | Infinity | 0.000 | | | 4.02 | Image sensor 140 |

In Table 15, the surface S5 is the surface of the third lens L3 facing the object side B1, the surface S6 is the surface connecting the third lens L3 and the fourth lens L4, and the surface S7 is the surface of the fourth lens L4 facing the image side B2. The surfaces S17 and S18 are the two opposite surfaces of the tenth lens L10.

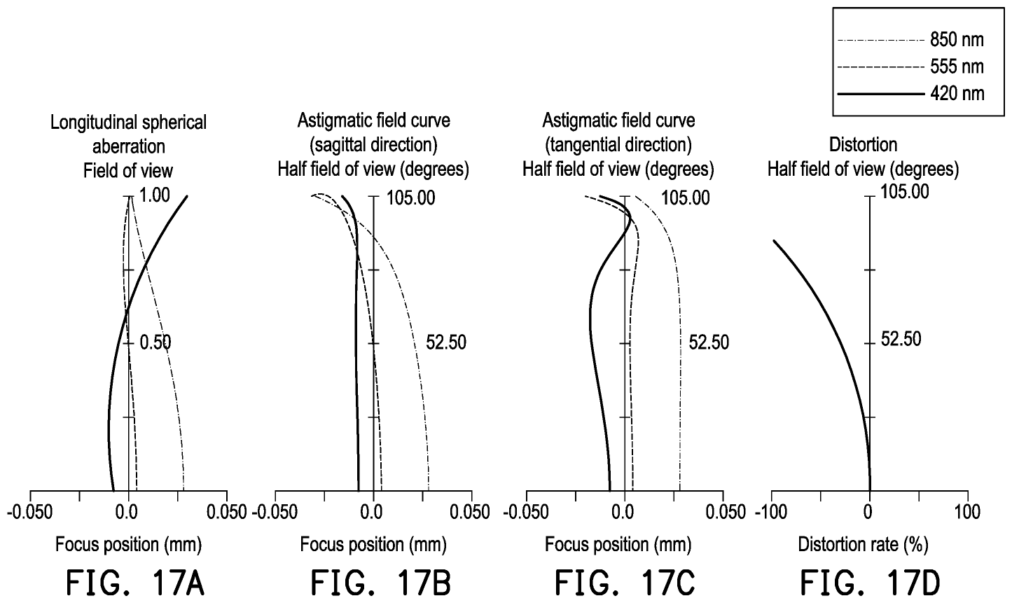

FIG. 17A to FIG. 17D are optical imaging quality graphs of the fixed focus image capturing lens of FIG. 16. FIG. 17A is a longitudinal spherical aberration diagram of the fixed focus image capturing lens 100g, FIG. 17B is an astigmatic field curve in the sagittal direction of the fixed focus image capturing lens 100g, FIG. 17C is an astigmatic field curve in the tangential direction of the fixed focus image capturing lens 100g, and FIG. 17D is a distortion diagram of the fixed focus image capturing lens 100g. The drawings are simulated using imaging rays with wavelengths of 850 nm, 555 nm, and 420 nm. It can be seen from FIG. 17A to FIG. 17D that the imaging quality of the fixed focus image capturing lens 100g is good.

The following Tables 16 and 17 are the optical parameters of the fixed focus image capturing lenses 100 and 100a to 100g of the first to eighth embodiments above:

TABLE 16

| | EFL | F# | FOV | TTL | BFL | IH | D1 |
|---|---|---|---|---|---|---|---|
| First | 2.091 | 2.1 | 214 | 34.55 | 3.36 | 4.503 | 23.66 |
| embodiment | | | | | | | |
| Second | 2.225 | 2.05 | 222 | 34.6 | 4.23 | 4.239 | 23.79 |
| embodiment | | | | | | | |
| Third | 2.225 | 2.05 | 222 | 34.87 | 3.46 | 4.177 | 25.02 |
| embodiment | | | | | | | |
| Fourth | 2.247 | 2.05 | 222 | 34.75 | 3.71 | 4.196 | 23.14 |
| embodiment | | | | | | | |
| Fifth | 2.238 | 2.05 | 220 | 34.71 | 3.51 | 4.110 | 25.00 |
| embodiment | | | | | | | |
| Sixth | 2.248 | 2.05 | 210 | 37.1 | 3.514 | 4.031 | 27.05 |
| embodiment | | | | | | | |
| Seventh | 2.191 | 2.05 | 210 | 34.9 | 3.31 | 4.040 | 25.18 |
| embodiment | | | | | | | |
| Eighth | 2.2 | 2.05 | 210 | 39.64 | 2.95 | 4.016 | 26.93 |
| embodiment | | | | | | | |
| Maximum | 2.248 | 2.10 | 222 | 39.64 | 4.23 | 4.503 | 27.05 |
| value | | | | | | | |
| Minimum | 2.091 | 2.05 | 210 | 34.55 | 2.95 | 4.016 | 23.14 |
| value | | | | | | | |
| ave + 7σ | 2.569 | 2.18 | 257 | 48.38 | 6.07 | 5.28 | 35.11 |
| ave − 7σ | 1.847 | 1.93 | 176 | 22.90 | 0.94 | 3.04 | 14.83 |

TABLE 17

| | | D1/ | | D1/ | DL/ | EFL/ | IH/ |
|---|---|---|---|---|---|---|---|
| | DL | DL | LT | LT | LT | LT | TTL |
| First | 7.81 | 3.03 | 31.19 | 0.76 | 0.25 | 0.07 | 0.13 |
| embodiment | | | | | | | |
| Second | 7.78 | 3.06 | 30.37 | 0.78 | 0.26 | 0.07 | 0.12 |
| embodiment | | | | | | | |
| Third | 7.93 | 3.16 | 31.41 | 0.80 | 0.25 | 0.07 | 0.12 |
| embodiment | | | | | | | |
| Fourth | 8.03 | 2.88 | 31.04 | 0.75 | 0.26 | 0.07 | 0.12 |
| embodiment | | | | | | | |
| Fifth | 7.86 | 3.18 | 31.20 | 0.80 | 0.25 | 0.07 | 0.12 |
| embodiment | | | | | | | |
| Sixth | 6.50 | 4.16 | 33.59 | 0.81 | 0.19 | 0.07 | 0.11 |
| embodiment | | | | | | | |
| Seventh | 7.31 | 3.45 | 31.59 | 0.80 | 0.23 | 0.07 | 0.12 |
| embodiment | | | | | | | |
| Eighth | 7.40 | 3.64 | 36.69 | 0.73 | 0.20 | 0.06 | 0.10 |
| embodiment | | | | | | | |
| Maximum | 8.03 | 4.16 | 36.69 | 0.81 | 0.26 | 0.07 | 0.13 |
| value | | | | | | | |
| Minimum | 6.50 | 2.88 | 30.37 | 0.73 | 0.19 | 0.06 | 0.10 |
| value | | | | | | | |
| ave + 7σ | 11.09 | 6.23 | 46.57 | 0.97 | 0.42 | 0.10 | 0.18 |
| ave − 7σ | 4.07 | 0.40 | 17.70 | 0.58 | 0.06 | 0.04 | 0.06 |

In Table 16 and Table 17, EFL is the effective focal length of the fixed focus image capturing lenses 100 and 100a to 100g; F # is the f-number of the fixed focus image capturing lenses 100 and 100a to 100g; FOV is the field of view of the fixed focus image capturing lenses 100 and 100a to 100g in the unit of degrees; TTL is the distance between the lens surface closest to the object side B1 (that is, the surface S1) of the fixed focus image capturing lenses 100 and 100a to 100g and the imaging plane (that is, the sensing surface of the image sensor 140) on the optical axis A; BFL is the back focal length of the fixed focus image capturing lenses 100 and 100a to 100g, that is, the distance between the lens surface closest to the image side B2 in the fixed focus image capturing lenses 100 and 100a to 100g and the imaging plane on the optical axis A; IH is the image height of the fixed focus image capturing lenses 100 and 100a to 100g; D1 is the diameter of the lens surface closest to the object side B1 (that is, the surface S1) in the fixed focus image capturing lenses 100 and 100a to 100g, that is, the lens outer diameter of the outermost surface of the first lens L1; DL is the diameter of the lens surface closest to the image side B2 in the fixed focus image capturing lenses 100 and 100a to 100g; LT is the distance between the outermost lens surfaces on the two sides of the fixed focus image capturing lenses 100 and 100a to 100g on the optical axis A, that is, the distance between the lens surface closest to the object side B1 (that is, the surface S1) in the fixed focus image capturing lenses 100 and 100a to 100g and the lens surface closest to the image side B2 on the optical axis A. The values in the row of the maximum value are the maximum values among all values of the first to eighth embodiments above; the values in the row of the minimum value are the minimum values among all values of the first to eighth embodiments above; the values in the row of the ave+7σ are the average values of all values of the first to eighth embodiments above plus 7 standard deviations; and the values in the row of the ave-7σ are the average values of all values of the first to eighth embodiments above minus 7 standard deviations.

In summary, in the fixed focus image capturing lens according to the embodiments of the disclosure, the distance difference between the 555 nm wavelength light focusing surface and the 850 nm wavelength light focusing surface is less than 20 μm, or the fixed focus image capturing lens substantially has day and night confocal characteristics, and the fixed focus image capturing lens has the above-mentioned features. Therefore, the fixed focus image capturing lens according to the embodiments of the disclosure can have a wide viewing angle, a high imaging quality, day and night confocal, and low chromatic aberration.

In terms of reducing the number of lenses, taking the fifth embodiment with 9 lenses disclosed in FIG. 9 as an example, for persons skilled in the art of lens design technology, in order to reduce the volume and reduce the manufacturing cost, the triple cemented lens (for example, the cemented lens C2) may be changed to the double cemented lens. Alternatively, the first lens L1 and the second lens L2 may be replaced by a lens with a greater absolute value of refractive power, the second lens L2 may be omitted, and the absolute value of the first lens L1 may be increased to obtain a lens composed of 8 lenses, so as to meet the requirements of the disclosure.

In terms of increasing the number of lenses, in order to facilitate production and improve resolution, for persons skilled in the art of lens design technology, a lens with high curvature and large thickness may be disassembled and replaced by two lenses due to difficult production; an aspherical lens may be replaced by 2 to 3 spherical lenses; and a lens may also be disassembled into a double cemented or triple cemented lens to eliminate aberration and improve resolution.

What is claimed is:

1. A fixed focus image capturing lens, comprising:
a first lens group, comprising a first lens, a second lens, a third lens, and a fourth lens in sequence from an object side of the fixed focus image capturing lens to an image side of the fixed focus image capturing lens, wherein refractive powers of the first lens, the second lens, and the third lens are all negative;
a second lens group, disposed between the first lens group and the image side of the fixed focus image capturing lens, and comprising four lenses having refractive power, wherein the four lenses comprise a cemented lens; and
an aperture, disposed between the first lens group and the second lens group;
and the fixed focus image capturing lens satisfying following conditions of:
(1) enabling a distance difference between a 555 nm wavelength light focusing surface and an 850 nm wavelength light focusing surface to be less than 20 μm; and
(2) 0.61<D1/LT<0.97, where D1 is a lens outer diameter of an outermost surface of the first lens, and LT is a distance between outermost lens surfaces on two sides of the fixed focus image capturing lens on an optical axis.

2. The fixed focus image capturing lens according to claim 1, wherein materials of all lenses in the fixed focus image capturing lens are all glass.

3. The fixed focus image capturing lens according to claim 1, wherein in the fixed focus image capturing lens, a number of lenses made of plastic material is at most 3.

4. The fixed focus image capturing lens according to claim 3, wherein the first lens is not made of plastic material.

5. The fixed focus image capturing lens according to claim 1, wherein the fixed focus image capturing lens comprises an aspherical lens.

6. The fixed focus image capturing lens according to claim 5, wherein the aspherical lens is one of following lenses: a lens second farthest or third farthest from the aperture in the first lens group, a lens farthest from the aperture in the second lens group, a lens closest to the aperture in the first lens group, or a lens closest to the aperture in the second lens group.

7. The fixed focus image capturing lens according to claim 1, wherein an f-number of the fixed focus image capturing lens falls within a range of 1.8 to 2.2.

8. The fixed focus image capturing lens according to claim 1, wherein the cemented lens of the second lens group is a triple cemented lens.

9. The fixed focus image capturing lens according to claim 8, wherein a ratio of a total thickness of the triple cemented lens on the optical axis to LT is between 0.06 and 0.28.

10. The fixed focus image capturing lens according to claim 1, wherein a ratio of a spacing between the first lens group and the second lens group on the optical axis to LT is between 0.08 and 0.31.

11. The fixed focus image capturing lens according to claim 1, wherein a ratio of a spacing between the first lens group and the second lens group on the optical axis to a distance between two surfaces closest to and farthest from the aperture of the first lens group on the optical axis is between 0.13 and 0.67.

12. The fixed focus image capturing lens according to claim 1, wherein the first lens group has five lenses, and lenses third farthest and fourth farthest from the aperture form a double cemented lens.

13. The fixed focus image capturing lens according to claim 12, wherein a surface of the lens third farthest from the aperture facing the aperture is convex.

14. The fixed focus image capturing lens according to claim 1, wherein the fixed focus image capturing lens meets 7.52<TTL/IH<9.87, where TTL is a distance between a lens surface farthest from the aperture of the first lens group and an imaging plane of the fixed focus image capturing lens on the optical axis, and IH is an image height of the fixed focus image capturing lens.

15. The fixed focus image capturing lens according to claim 1, wherein the first lens group has five lenses, refractive powers of the five lenses are negative, negative, negative, positive, and positive in sequence from a side far from the aperture to a side close to the aperture, the second lens group has four lenses, and refractive powers of the four lenses are positive, negative, positive, and positive in sequence from a side close to the aperture to a side far from the aperture.

16. The fixed focus image capturing lens according to claim 1, wherein a modulation transfer function of the fixed focus image capturing lens at a spatial frequency of 120 lp/mm and a wavelength of 420 nm to 850 nm is greater than 40%.

17. The fixed focus image capturing lens according to claim 1, wherein a number of lenses having refractive power of the fixed focus image capturing lens is 8 to 10.

18. The fixed focus image capturing lens according to claim 1, wherein a number of lenses having refractive power of the fixed focus image capturing lens is 9, a number of lenses having refractive power of the first lens group is 5, and a number of lenses having refractive power of the second lens group is 4.

19. A fixed focus image capturing lens, comprising:
a first lens group, disposed with a first lens having negative refractive power, a second lens having refractive power, and a third lens having a negative refractive power in sequence from a magnification side of the fixed focus image capturing lens to a reduction side of the fixed focus image capturing lens;
a second lens group, disposed between the first lens group and the reduction side, and comprising at least one cemented lens; and
an aperture, disposed between the first lens group and the second lens group;
a lens surface closest to the reduction side of the second lens group being concave;
and the fixed focus image capturing lens being substantially a day and night confocal lens and meeting a following condition of:
0.06<EFL/LT<0.08, where EFL is an optical effective focal length of the fixed focus image capturing lens, and LT is a distance between outermost lens surfaces on two sides of the first lens group and the second lens group on an optical axis.

20. The fixed focus image capturing lens according to claim 19, wherein the fixed focus image capturing lens enables a distance difference between a 555 nm wavelength light focusing surface and an 850 nm wavelength light focusing surface to be less than 20 μm.
